(19) United States
(12) Patent Application Publication
(10) Pub. No.: US 2024/0056997 A1
(43) Pub. Date: Feb. 15, 2024

(54) METHODS AND APPARATUSES FOR SIDELINK POSITIONING

(71) Applicant: INTERDIGITAL PATENT HOLDINGS, INC., Wilmington, DE (US)

(72) Inventors: Tuong Hoang, Montreal (CA); Fumihiro Hasegawa, Westmount (CA); Jaya Rao, Montreal (CA); Moon IL Lee, Melville, NY (US); Paul Marinier, Brossard (CA); Ghyslain Pelletier, Montreal (CA); Aata El Hamss, Laval (CA)

(73) Assignee: INTERDIGITAL PATENT HOLDINGS, INC., Wilmington, DE (US)

(21) Appl. No.: 18/270,887

(22) PCT Filed: Jan. 12, 2022
(86) PCT No.: PCT/US2022/012201

§ 371 Date: Jul. 5, 2023

Related U.S. Application Data
(60) Provisional application No. 63/136,558, filed on Jan. 12, 2021.
(60) Provisional application No. 63/228,955, filed on Aug. 3, 2021.

(51) Int. Cl. H04W 56/00; H04L 5/00; H04W 64/00

(52) U.S. Cl. CPC H04W 56/0015; H04L 5/0053; H04W 64/00

(57) ABSTRACT

A method performed by a first Wireless Transmit/Receive Unit (WTRU) may comprise requesting support from one or more potential assistant WTRUs (A-WTRUs); receiving a response message from one or more potential A-WTRUs, wherein the response message includes information indicating a coverage status within a network of the one or more potential A-WTRUs; determining, based on the received response messages, a set of A-WTRUs from the one or more potential A-WTRUs; determining, based on the coverage status of each one of the determined set of A-WTRUs, a synchronization source; and reporting, to the determined set of A-WTRUs, the determined synchronization source.

### CROSS-REFERENCE TO RELATED APPLICATIONS

This application claims the benefit of U.S. Provisional Application No. 63/136,558, filed Jan. 12, 2021 and U.S. Provisional Application No. 63/228,955, filed Aug. 3, 2021, the contents of which are incorporated herein by reference.

### BACKGROUND

The Third Generation Partnership Project (3GPP) specifications for New Radio Vehicle-to-Everything (V2X) may support sidelink communication among different vehicles. Resources for sidelink transmission/reception may be structured as resource pools. A resource pool may consist of a set of continuous frequency resources repeating in time following a bitmap pattern.

A wireless transmit/receive unit (WTRU) may be configured with or configured to use one or multiple resource pool. For in-coverage WTRUs, the resource pool may be configured via a System Information Block (SIB) and/or via Radio Resource Control (RRC) signaling. For out of coverage WTRUs, the resource pool may be pre-configured.

Each sidelink transmission may span within one slot over a PSSCH and/or PSCCH. A PSSCH and PSCCH may use FDM and TDM multiplexing. Sidelink control information (SCI) may be divided into two parts which may be first stage SCI and second stage SCI. First stage SCIs may indicate resources used for sidelink transmission, Quality of Service (QoS) of the transmission (e.g., priority), Demodulation Reference Signal (DMRS), or Phase Tracking Reference Signal (PTRS) used for the sidelink transmission and/or the second SCI format. A second stage SCI may indicate remaining control information. SCI may be used to reserve a resource or resources for future transmission within a resource pool.

From sidelink scheduling perspective, a sidelink resource may be scheduled by the network (i.e., Mode 1) and autonomously selected by the WTRU (i.e., Mode 2). If the WTRU uses Mode 2, it may perform sensing by decoding SCI from other WTRUs before selecting the sidelink resources to avoid selecting the resources reserved by other WTRUs.

SL-CSI-RS may be supported for unicast to support the transmitting (Tx) WTRU in determination of Tx parameters (e.g., power and rank). A Tx WTRU may indicate the presence of one or more Sidelink Channel State Information Reference Signals (SL-CSI-RSs) by using SCI. CSI-RS transmission may trigger CSI reporting. And CSI reporting latency may be configured via a PC5 RRC message. Each reporting instance may be associated with one or more SL-CSI-RS transmissions.

3GPP may provide for positioning specified DL-based, UL-based, and DL+UL-based positioning methods. In a DL-based positioning method, DL-PRS may be sent from multiple Transmit Receive Points (TRPs) to the WTRU. The WTRU may observe and/or measure downlink signals from the TRPs. For a WTRU-B method, the WTRU may calculate its position, and for WTRU-A method, the WTRU may return a downlink measurement to the network. For an angle-based method, a WTRU may report the Angle of Arrival (AoA) and Reference Signal Received Power (RSRP) of the downlink signals from the TRPs. For timing-based methods, the WTRU may report a Reference Signal Time Difference (RSTD). The above methods may require transmission timing synchronization among the TRPs. The positioning calculation errors mostly comes from synchronization error and multipath.

In uplink positioning methods, a WTRU may send Uplink Positioning Reference Signals (UL-PRSs) for positioning, configured by RRC, to the TRP. The network may then calculate the position of the WTRU based on the coordination of all the TRPs receiving UL-PRS from the WTRU.

In UL and DL-based methods, a WTRU may measure an Rx-Tx time difference between received DL-PRS and UL-PRS transmitted. The Rx-Tx time difference and RSRP may be reported to the network. The network may then coordinate the TRPs to calculate the position of the WTRU.

### SUMMARY

Methods and apparatuses for sidelink positioning are described herein. A method performed by a first Wireless Transmit/Receive Unit (WTRU) may comprise requesting support from one or more potential assistant WTRUs (A-WTRUs); receiving a response message from one or more potential A-WTRUs, wherein the response message includes information indicating a coverage status within a network of the one or more potential A-WTRUs; determining, based on the received response messages, a set of A-WTRUs from the one or more potential A-WTRUs; determining, based on the coverage status of each one of the determined set of A-WTRUs, a synchronization source; and reporting, to the determined set of A-WTRUs, the determined synchronization source.

The method may further compromise determining of the set of A-WTRUs from the one or more potential A-WTRUs is based on a Quality of Service (QoS) requirement of a positioning service of the first WTRU. The method may further compromise, wherein on a condition that each of the A-WTRUs of the determined set are within coverage of the network, the determined synchronization source is a base station. The method may further compromise, wherein on a condition that at least one of the A-WTRUs of the determine set is not within coverage of the network, the determined synchronization source is any WTRU. The method may further compromise the any WTRU being the first WTRU.

The method may further compromise the first WTRU sending information to the determined set of A-WTRUs for receiving a Sidelink (SL) Positioning Synchronization Signal (SLPSS) transmission. The method may further compromise the first WTRU sending the SLPSS transmission to the determined set of A-WTRUs to synchronize the SL Positioning Reference Signals (SL-PRSs) for the determined set of A-WTRUs. The method may further compromise the SLPSS transmission being one of a SL-PRS, Sidelink Synchronization Signal (SLSS), Demodulation Reference Signal (DMRS), Phase Tracking Reference Signal (PTRS), or Channel State Information Reference Signal (CSI-RS). The method may further compromise the first WTRU determining a periodicity of the SLPSS transmission based on a Quality of Service (QoS) requirement of a positioning service associated with the determined set of A-WTRUs. The method may further compromise, the first WTRU sending the SLPSS transmission using the determined periodicity.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example in which the WTRU uses SCI to indicate a SL-PRS pattern;

FIG. 3 is a flowchart with steps for performing an example sidelink positioning procedure;

FIG. 4 is an example signaling flow in which a P-WTRU transmit SL-PRS and all A-WTRUs receives SL-PRS (e.g., a SL-PRS transmission-based method);

FIG. 5 is an example signaling flow in which all A-WTRU transmit SL-PRS, P-WTRU receives SL-PRS (e.g., a SL-PRS transmission-based method);

FIG. 6 is an example signaling flow in which all WTRUs transmit/receive SL-PRS (e.g., a SL-PRS transmission and reception-based method);

FIG. 7 portrays an example in which a WTRU determines which resource to use to transmit synchronization signals;

FIG. 8 portrays an example in which a WTRU dynamically selects a synchronization transmission resource;

FIG. 9 is a diagram illustrating a scenario in which all A-WTRUs are in coverage and a scenario in which one more A-WTRUs are out of coverage; FIG. 10 is a diagram illustrating an exemplary synchronization offset between two WTRUs; and

FIG. 11 a diagram illustrating an exemplary procedure to determine the offset time between two WTRUs.

### DETAILED DESCRIPTION

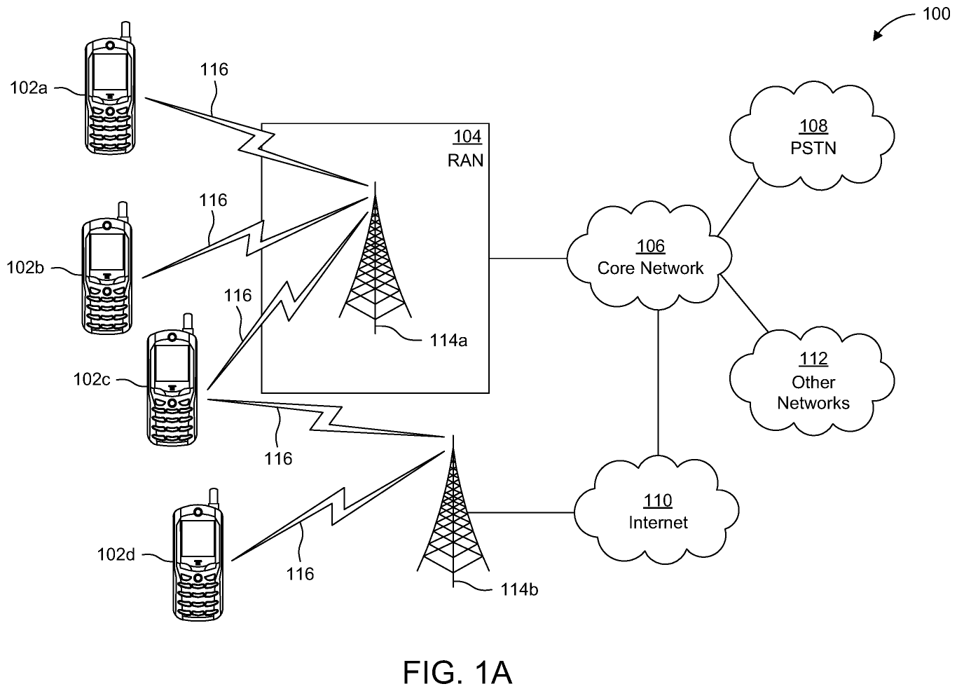

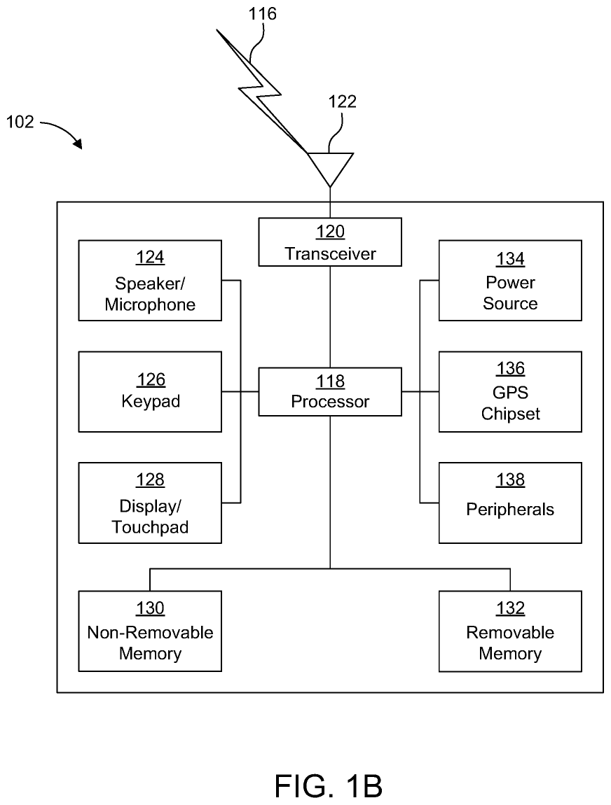

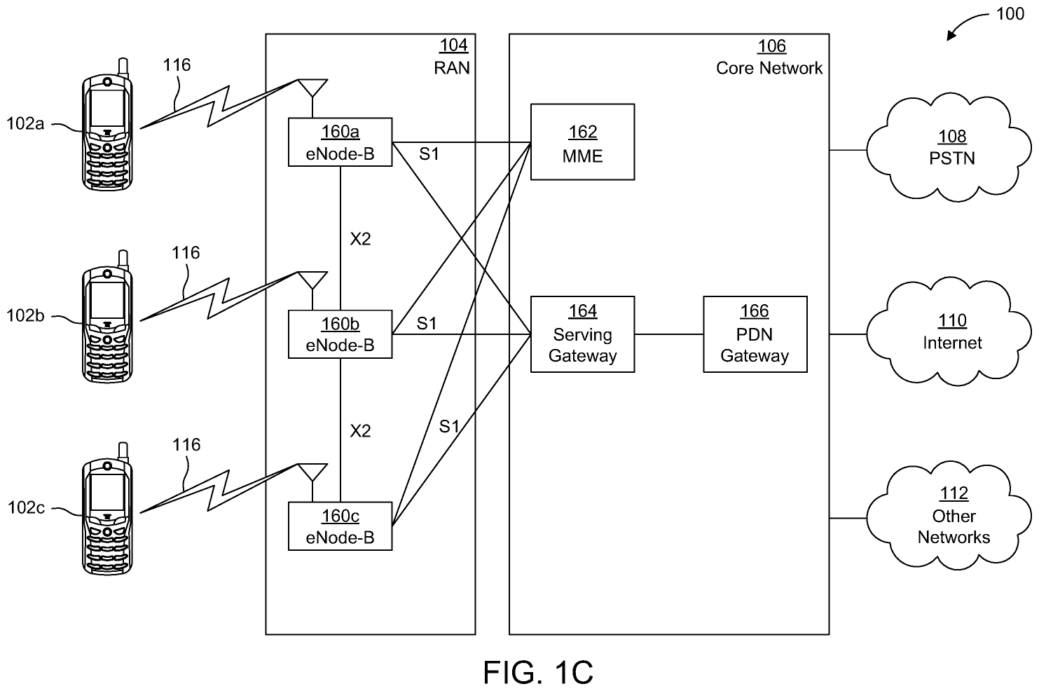

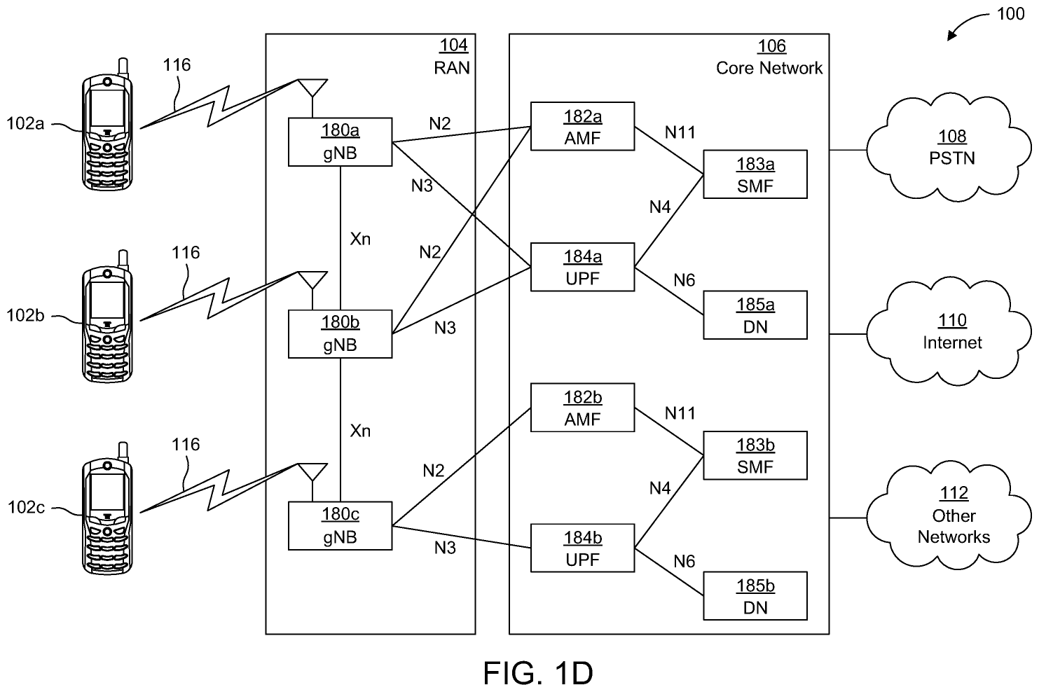

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRU 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Abbreviations and acronyms as used herein are provided as follows:

ACK Acknowledgement

AoA Angle of Arrival

AoD Angle of Departure

A-WTRU Assistant-WTRU

BLER Block Error Rate

CB Contention-Based (e.g. access, channel, resource)

CBR Channel Busy Ratio

CP Cyclic Prefix

CP-OFDM Conventional OFDM (relying on cyclic prefix)

CQI Channel Quality Indicator

CR Channel Occupancy Ratio

CRC Cyclic Redundancy Check

CSI Channel State Information

D2D Device to Device transmissions (e.g. LTE Sidelink)

DCI Downlink Control Information

DFT-s-OFDM Digital Fourier Transform spread OFDM

DL Downlink

DMRS Demodulation Reference Signal

FB Feed Back

FDD Frequency Division Duplexing

FDM Frequency Division Multiplexing

InC In coverage of the cell

LBT Listen-Before-Talk

LLC Low Latency Communications

LTE Long Term Evolution e.g. from 3GPP LTE R8 and up

MAC Medium Access Control

NACK Negative ACK

MBB Massive Broadband Communications

MC MultiCarrier

MCS Modulation and Coding Scheme

OFDM Orthogonal Frequency-Division Multiplexing

OOB Out-Of-Band (emissions)

OoC Out of coverage of the cell

OTDOA Observed Time Difference of Arrival

P_{cmax} Total available UE power in a given TI

PC5-S PC5 signaling

PDB Packet Delay Budget

PHY Physical Layer

PSCCH Physical SL Control Channel

PSFCH Physical SL Feedback Channel

PSS Primary Synchronization Signal

PSSCH Physical SL Shared Channel

PSSCH-RSRP PSSCH Reference Signal Received Power

P-WTRU Positioning WTRU

QoS Quality of Service (from the physical layer perspective)

RNTI Radio Network Identifier

RRC Radio Resource Control

RRM Radio Resource Management

RS Reference Signal

RSRP Reference Signal Receive Power

RSRQ Reference Signal Receive Quality

RSTD Reference Signal Time Difference

RTT Round-Trip Time

S-RSSI SL Received Signal Strength Indicator

SL Side Link

SL-PRS Sidelink Positioning Reference Signal

SS Synchronization Signal

SSS Secondary Synchronization Signal

SLSS Sidelink synchronization signals

SL-PRS Sidelink Positioning Reference Signal

SL-RSRP Sidelink Reference Signal Receive Power

SL-RSRQ Sidelink Reference Signal Receive Quality

SL-RSSI Sidelink Received Signal Strength Indicator

S-PSS Sidelink Primary synchronization signal

S-PSS Sidelink Secondary synchronization signal

TB Transport Block

TDD Time-Division Duplexing

TDM Time-Division Multiplexing

ToA Time of Arrival

ToD Time of Departure

TTI Transmission Time Interval

TRP Transmission/Reception Point

TRX Transceiver

UL Uplink

URLLC Ultra-Reliable and Low Latency Communications

V2X Vehicular communications

Current methods for Uu positioning may have several shortcomings. One shortcoming may be coverage. For example, in some cases, Uu positioning may not assist in locating out-of-coverage WTRUs. Another shortcoming may be accuracy. For example, multipath propagation may severely degrade performance for DL/UL/DL&UL based methods. Another shortcoming may be latency. For example, high accuracy positioning may introduce latency due to higher layer configuration required in Uu positioning. Another shortcoming may be power efficiency. For example, for Uu positioning, power consumption may be a problem for WTRUs because a WTRU may need to boost its Tx power to reach neighbor cells.

Sidelink positioning may bring benefits. For example, coverage may be enhanced. Sidelink positioning may provide positioning to both in coverage and out-of-coverage WTRUs. Accuracy may be enhanced. Taking advantages of assisting WTRUs covering blind spots, sidelink positioning may provide an additional dimension to improve positioning accuracy. Latency may be enhanced. Sidelink positioning may quickly supplement positioning, reducing latency to achieve high accuracy by autonomous formulation of positioning group. Power efficiency may be enhanced. For sidelink positioning, since transmission power may be reduced and positioning workload may be distributed by using assisting WTRUs, power consumption for P-WTRU may be improved.

Sidelink positioning for a P-WTRU may require a set of assistant-WTRUs (A-WTRUs) and synchronization of the reference signal transmission/reception among the WTRUs. Therefore, methods to determine the set of A-WTRUs to support location of a P-WTRU are desirable. After the set of A-WTRU is formulated, methods to synchronize the SL-PRS transmission/reception to facilitate the measurement and reporting may be necessary.

Embodiments that may provide solutions to some or all of the above problems are provided herein. Embodiments described herein for positioning may be used for ranging without any limitation. Positioning may be referred to as a method or scheme to estimate geographical location of a WTRU. Ranging may be referred to as a method or scheme to estimate distance between WTRUs. “Positioning of a WTRU” or “location information of a WTRU” may be interchangeably used with “a distance between WTRUs” when a method is used for ranging.

A summary encompassing at least some of the described embodiments is provided herein. The following described exemplary embodiments may focus on a P-WTRU's behavior. In some embodiments, a WTRU (i.e., P-WTRU) may perform the following procedure upon the position request from higher layers, or any logical equivalent layer.

A WTRU may broadcast positioning assistant messages, which may include its positioning status (e.g., its estimated location and error information, its zone ID, speed, direction, etc.), QoS requirements of the positioning service (e.g., positioning accuracy, latency), and/or supported positioning methods for sidelink (e.g., OTDOA, RTT, AoA, AoD, etc.). A WTRU may receive response messages from the potential assistant WTRUs.

A WTRU may determine the set of A-WTRUs and the sync-source-WTRU (to serve as the sync source to the group) based on the QoS requirements of the positioning service, the location status of each A-WTRU (e.g., the coarse distance to the P-WTRU), and/or a sidelink measurement of each WTRU (e.g., RSRP of the response message, LOS/NLOS status). A WTRU may decide when/whether to synchronize. In some examples, the P-WTRU may require more A-WTRUs for high positioning accuracy and less A-WTRUs for low positioning accuracy. The P-WTRU may select N A-WTRUs having the highest RSRP or having the shortest zone distance, etc. In some examples, the P-WTRU may select the sync-source-WTRU in the middle of the group or the WTRU having the highest position accuracy, sync to the highest sync source, etc.

A WTRU may determine the positioning method (e.g., RTT, OTDOA, AoA, AoD) based on the positioning status of the A-WTRUs and the QoS requirements of the positioning. A WTRU may select the SL-PRS transmission pattern (the SL-PRS resource pool, number of subchannels for each transmission, number of repetitions, periodicity, time/frequency offset, comb values, etc.) and measurement reporting configuration based on the set of A-WTRU, QoS of the positioning service, CBR of the resource pool, CR of the WTRU, etc. A WTRU may send the SL-PRS transmission pattern and reporting configuration to the set of A-WTRUs in a positioning-assistant-ack message.

For some methods, such as OTDOA-based sidelink positioning methods, if the WTRU determines to receive SL-PRS, the WTRU may receive the synchronization signal from the sync-source-WTRU and SL-PRS from the normal A-WTRUs. The WTRU may calculate its position based on the reception timing of synchronization signal of the sync-source-WTRU, SL-PRS of the normal A-WTRUs, and the relative position among each pair of A-WTRUs. If the WTRU determines to transmit SL-PRS, the WTRU may receive one or more synchronization signals from the sync-source-WTRU. The WTRU may use the timing of the received synchronization signal from sync-source-WTRU to transmit SL-PRS. The WTRU may receive the measurement report from each A-WTRU and calculate its position.

The following examples may focus on an A-WTRU's behavior. In the following embodiments, a WTRU (i.e., A-WTRU) may perform the following upon the positioning request from higher layers such as RRC layer or any logical equivalent.

A WTRU may receive the positioning assistant message from another WTRU (i.e., P-WTRU). The WTRU may determine whether to transmit the response message (i.e., whether to become an A-WTRU) based on its positioning status, sidelink measurement, number of supporting P-WTRUs, and/or its supported sidelink positioning methods. The response message may include the WTRU location status and the supported sidelink positioning methods. The WTRU may address how to coordinate the pattern of multiple P-WTRUs. For example, the WTRU may only respond if it detects LOS and/or RSRP is greater than a threshold. The WTRU may be allowed to support at most N P-WTRUs.

The WTRU may receive the positioning-assistant-ack message. If the WTRU is selected as a sync-source-WTRU, the WTRU may transmit the synchronization signal in the configured resource. Otherwise (i.e., if the WTRU is selected as a normal A-WTRU), the WTRU may receive the synchronization signal from the sync-source-WTRU.

For some methods, such as OTDOA-based sidelink positioning methods, if the WTRU is configured to transmit a SL-PRS, the WTRU may use the reference timing of the synchronization signal to transmit the SL-PRS. If the WTRU is configured to receive a SL-PRS, the WTRU may receive the SL-PRS from another WTRU (P-WTRU). The WTRU may report the sidelink measurement (e.g., RSTD between two SL-PRS or between one SL-PRS and the synchronization signal).

The following examples may focus on the P-WTRU's behavior. In some embodiments, a WTRU (i.e., P-WTRU) may perform the following upon a position request from higher layers (e.g., RRC or any logical equivalent) or the network.

A WTRU may broadcast positioning assistant messages, which may include its positioning status (e.g., its estimated location and error information, its zone ID, speed, direction, etc.), QoS requirements of the positioning service (e.g., positioning accuracy, latency), supported positioning methods (OTDOA, RTT, AoA, AoD, etc.), and/or cell ID.

The WTRU may receive the response messages from the potential assistant WTRUs. The WTRU may determine the set of potential A-WTRUs based on the QoS requirements of the positioning service, the location status of each A-WTRUs (e.g., relative distance with the P-WTRUs), sidelink measurement of each WTRU (e.g., RSRP of the response message, LOS/NLOS status), the coverage status, connection status and cell IDs of the potential A-WTRUs. The WTRU may report the set of potential A-WTRUs to the network.

The WTRU may receive, from the network, the set of A-WTRUs (from the set of potential A-WTRUs), the reference WTRU (in coverage WTRU), SL-PRS transmission/reception pattern and reporting configuration for itself and/or the set of A-WTRUs. The WTRU may forward the set of A-WTRUs, the reference WTRU, SL-PRS transmission/reception pattern, and reporting configuration to the A-WTRUs.

For OTDOA methods, if the WTRU is configured to receive a SL-PRS, the WTRU may receive the synchronization signal from the reference WTRU and SL-PRS from the normal A-WTRUs. The WTRU may perform sidelink measurements (RSTDs between SL-PRS and synchronization signal from the reference WTRU). The WTRU may report the sidelink measurement or measurements to the gNB. If the WTRU is configured to transmit SL-PRS, the WTRU may receive synchronization signals from the reference WTRU. The WTRU may use the timing of the received synchronization signal to transmit SL-PRS. The WTRU may receive the measurement report from each A-WTRU. The WTRU may report the combined sidelink measurement from the A-WTRUs to the gNB.

The following examples may focus on the A-WTRU's behavior. In some embodiments, a WTRU (i.e., A-WTRU) may perform the following steps upon the request from an upper layer.

The WTRU may receive the positioning assistant message from another WTRU (i.e., P-WTRU). The WTRU may determine whether to transmit the response message (i.e., the WTRU may become an A-WTRU) based on QoS requirements of the positioning service, its positioning status, sidelink measurement, number of supporting P-WTRUs, its supported positioning methods, coverage status, connection status, and cell ID. The response message may include the WTRU location status and the supported positioning methods.

The WTRU may receive the positioning-assistant-ACK message. If the WTRU is selected as a reference WTRU, the WTRU may use the downlink timing a reference to transmits the synchronization signal in the configured resource. Otherwise (i.e., if the WTRU is selected as a normal A-WTRU), the WTRU may receive the synchronization signal from the reference WTRU.

For OTDOA methods, if the WTRU is configured to transmit the SL-PRS, the WTRU may use the reference timing of the synchronization signal to transmit the SL-PRS. If the WTRU is configured to receive SL-PRS, the WTRU may receive the SL-PRS from another WTRU or WTRUs (e.g., P-WTRUs). The WTRU may report the sidelink measurement (e.g., RSTD between two SL-PRS or between one SL-PRS and the synchronization signal) to the P-WTRU.

Described herein are embodiments related to the design of the SL-PRS. In some embodiments, a WTRU may determine the signals for the SL-PRS. For example, a WTRU may use one or any of the following reference signals as an SL-PRS: DMRS of PSSCH and/or PSCCH; SLSS (e.g., S-PSS, S-SSS); PTRS; SL-CSI-RS; or a new RS designed for positioning purposes.

In some embodiments, a WTRU may be configured with multiple SL-PRS types. The WTRU may be configured or pre-configured to use one or multiple SL-PRS types. Each type may be associated with the reference signal, the resources, etc., used for SL-PRS transmission. For example, the WTRU may be configured or pre-configured with two SL-PRS types. The first SL-PRS type may use DMRS of PSSCH and/or PSCCH. This SL-PRS type may be transmitted together with sidelink data. The second SL-PRS type may use a new RS designed for positioning purposes. This SL-PRS type may or may not be transmitted together with sidelink data.

A SL-PRS type may be determined based on one or more of following parameters/configurations: (1) aperiodic transmission, semi-persistent transmission, or periodic transmission; (2) bandwidth (e.g., number of subchannel used for SL-PRS transmission); (3) frequency density (e.g., number of REs used for SL-PRS per RB in a same OFDM symbol); (4) time density (e.g., number of OFDM symbols containing SL-PRS in a slot); (5) transmission power (e.g., whether power boosting is used or not); (6) associated control channel (e.g., whether SL-PRS transmission is indicated by SCI or not); or (7) priority level (e.g., each SL-PRS type may have a different priority level for Tx and Rx). The priority level may be used to determine whether the SL-PRS Tx/Rx should be dropped when it overlaps with other higher priority channel/signal Rx/Tx due to the half-duplexing capability of the WTRU.

In some embodiments, a WTRU may determine the SL-PRS type. The WTRU may determine which SL-PRS type to use based on one or any combination of factors. For example, the WTRU may determine the type to use based on the resource pool used or determined for SL-PRS transmission. For instance, the WTRU may be configured or pre-configured with multiple resource pools, and each resource pool may be associated with one or more SL-PRS type. The WTRU may determine which SL-PRS type to transmit based on the resource pool used or determined for SL-PRS transmission/reception. Herein, the term “resource pool” may be interchangeably used with Tx resource pool and Rx resource pool.

The WTRU may determine the SL-PRS type to use based on QoS requirements of the positioning service. For example, the WTRU may use a first SL-PRS type (i.e., the SL-PRS using DMRS of PSSCH and/or PSCCH) if the positioning service requires low positioning accuracy. Alternatively, or additionally, the WTRU may use the second SL-PRS type (i.e., the SL-PRS using a new RS designed for positioning) if the positioning service requires high positioning accuracy. In another example, SL-PRS type may be determined based on the QoS (e.g., priority, latency, etc.) of the associated traffic, service, and/or packet. For example, SL-PRS may be transmitted within a PSSCH resource and its associated PSCCH may indicate the presence of the SL-PRS in the scheduled PSSCH. In the PSCCH (e.g., either 1st stage SCI or 2nd stage SCI), the corresponding QoS of the PRS transmission may be indicated. Based on the QoS indication, the SL-PRS type may be determined.

The WTRU may determine the SL-PRS type to use based on a CBR of the resource pool. For example, the WTRU may use the first SL-PRS type if the CBR of the resource pool is greater than a threshold and it may use the second SL-PRS type if the CBR of the resource pool is smaller than a threshold.

The WTRU may determine the SL-PRS type to use based on positioning information and/or the movement information of the WTRU. For example, the WTRU may use one SL-PRS type for low speed and/or relative speed with another WTRU and it may use another SL-PRS type for high speed and/or relative speed with another WTRU.

The WTRU may determine the SL-PRS type to use based on a distance between one WTRU (e.g., a P-WTRU) and another WTRU (e.g., an A-WTRU) and/or at least one sidelink channel measurement between two WTRUs. For example, the WTRU may use the first SL-PRS type if the distance between two WTRUs is greater than a threshold and it may use the second SL-PRS type if the distance between two WTRUs is smaller than a threshold. For example, the WTRU may use a first SL-PRS type (e.g., the first SL-PRS type) if a sidelink channel measurement between two WTRUs (e.g., SL-RSRP, SL-RSSI, SL-RSRQ) is less than a threshold and it may use a second SL-PRS type (e.g., the second SL-PRS type) if the sidelink channel measurement between two is greater than a threshold.

The WTRU may determine the SL-PRS type to use based on coverage information and/or WTRU state information. For example, the WTRU may use the one SL-PRS type (e.g., the first SL-PRS type) if both WTRUs are in coverage and it may use another SL-PRS type (e.g., the second SL-PRS type) if one of the WTRUs is out of network coverage.

The WTRU may determine the SL-PRS type to use based on a property or measurement of a received SL-PRS. For example, the WTRU may use a first SL-PRS type if it received a first SL-PRS of a first type with a measurement above a threshold, and a second SL-PRS type if it received a second SL-PRS of a second type with a measurement above a threshold. The measurement may consist of at least one of signal strength, signal quality, doppler, coherence time, delay spread or coherence bandwidth estimate.

The WTRU may determine the SL-PRS type to use based on a RRC configuration. For example, a group of WTRUs coordinating for SL positioning may negotiate to determine SL-PRS type and configure via a PC5-RRC.

The WTRU may determine the SL-PRS type to use based on a minimum communication range configured, or used.

In some embodiments, a WTRU may determine the resource pool for a SL-PRS. For instance, in some methods, the WTRU may be configured or pre-configured with multiple resource pools for transmitting a SL-PRS. The WTRU may determine which resource pool to transmit the SL-PRS based on one or any combination of the following. For example, a WTRU may determine the resource pool for transmitting the SL-PRS based on QoS requirements of the positioning service. For instance, the WTRU may be configured for one or more SL-PRS patterns in each resource pool. Each SL-PRS pattern may be associated with one or more sets of QoS requirements. The WTRU may then determine which resource pool to select based on the QoS requirements of the positioning service.

A WTRU may determine the resource pool for transmitting a SL-PRS based on the used positioning methods. For example, the WTRU may be configured or pre-configured with one or multiple positioning methods (e.g., OTDOA, AoA, AoD, RTT, and/or any combination of these methods) per resource pool. The WTRU may then determine the resource pool to use based on its used positioning method.

A WTRU may determine the resource pool for transmitting SL-PRS based on positioning information and/or movement information of the WTRU.

A WTRU may determine the resource pool for transmitting SL-PRS based on the distance between one WTRU (e.g., a P-WTRU) and another WTRU (e.g., an A-WTRU) and/or the sidelink channel between two WTRUs. For example, the WTRU may be configured or pre-configured with multiple resource pools. Each resource pool may be associated with the maximum and/or maximum distance of two WTRUs in a group. The WTRU may then determine which resource pool to use accordingly based on the distance of the WTRUs in the group.

A WTRU may determine the resource pool for transmitting SL-PRS based on coverage information and/or WTRU state information.

A WTRU may determine the resource pool for transmitting SL-PRS based on movement information of the WTRU. For example, the WTRU may be configured or pre-configured with multiple resource pools. Each resource pool may be associated with the maximum and/or minimum speed/relative speed of a WTRU. The WTRU may then determine which resource pool to use based on the speeds of the WTRUs in the group.

In some embodiments, a WTRU may use SCI to indicate information about the SL-PRS transmission. For instance, in some methods, the WTRU may transmit SL-PRS according to a pattern. The SL-PRS pattern may include one or any combination of the following: (1) the number of subchannels used for each SL-PRS transmission; (2) the number of repetitions; (3) a sequence ID; (4) a cyclic shift; (5) a muting pattern; (6) a periodicity of the SL-PRS; (7) a time/frequency offset; or (8) a comb value.

In some methods, the WTRU may use SCI to indicate a SL-PRS transmission. This method may be used to help one WTRU avoid SL-PRS transmission of another WTRU by performing sensing (e.g., decoding SCI). The WTRU may use one or any combination of the following procedures SCIs to indicate an SL-PRS pattern. For example, the WTRU may use SCI associated with the SL-PRS transmission. In some cases, the system may configure a set of SL-PRS pattern. The WTRU may then indicate the pattern index in the SCI. In some cases, the WTRU may indicate the SL-PRS pattern in the first and/or second SCI. The pattern may be indicated implicitly by a second SCI format or explicitly using one or multiple bitfields in the SCI. Each bitfield may represent one or a combination of the parameters defined for the SL-PRS pattern.

In some examples, the WTRU may use SCI associated with the other transmission. For example, in some cases, the WTRU may be configured or pre-configured with two resource pools in which one resource pool may be used to transmit normal sidelink data and the other resource pool may be used to transmit SL-PRS. The WTRU may use the SCI associated with data transmission in one resource pool to indicate/reserve the SL-PRS transmission pattern in another resource pool.

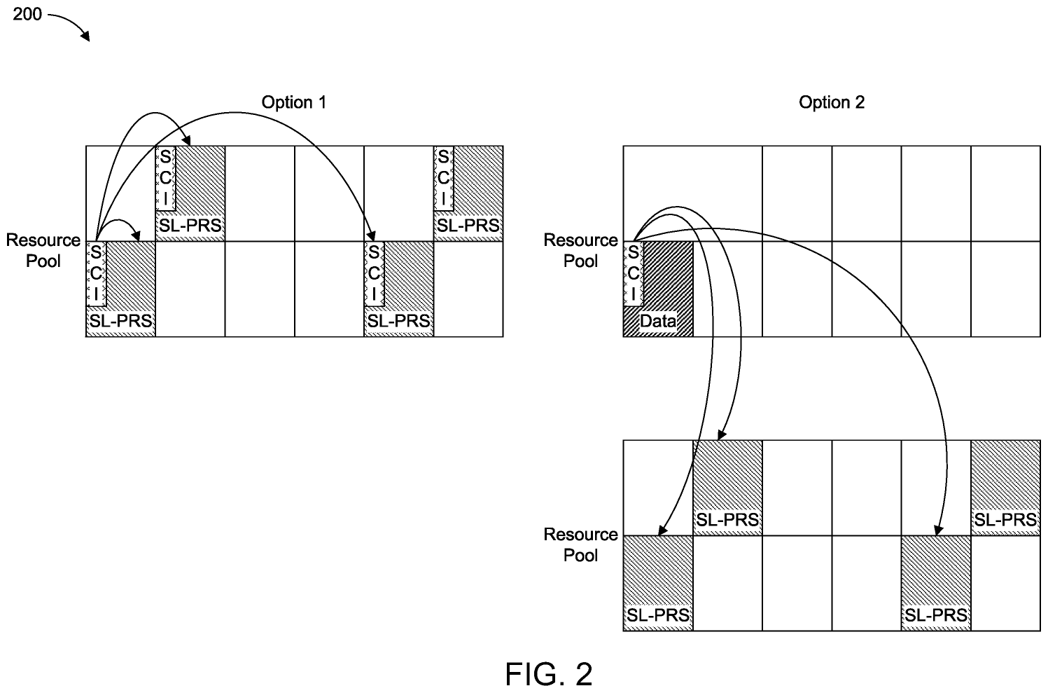

FIG. 2 is an exemplary diagram 200, in which the WTRU uses SCI to indicate an SL-PRS pattern. As shown in FIG. 2, in Option 1, the WTRU may use SCI associated with the SL-PRS transmission to indicate the SL-PRS pattern. In Option 2, the WTRU may use SCI associated with data transmission (possibly in another resource pool) to indicate the SL-PRS pattern.

In some embodiments, the WTRU (e.g., P-WTRU) may use higher layer messaging (e.g., PC5 RRC, NAS, MAC CE, or any logical equivalent) to indicate the SL-PRS transmission. In some embodiments, the WTRU may be configured or pre-configured with two resource pools in which one resource pool may be used to indicate the SL-PRS pattern transmitted in the other resource pool. In some approaches, the WTRU may be configured or pre-configured with one resource pool for both SL-PRS transmission and data transmission. The WTRU may use data transmission in the same resource pool to indicate the SL-PRS pattern. This approach may be used to avoid blind detection of SL-PRS.

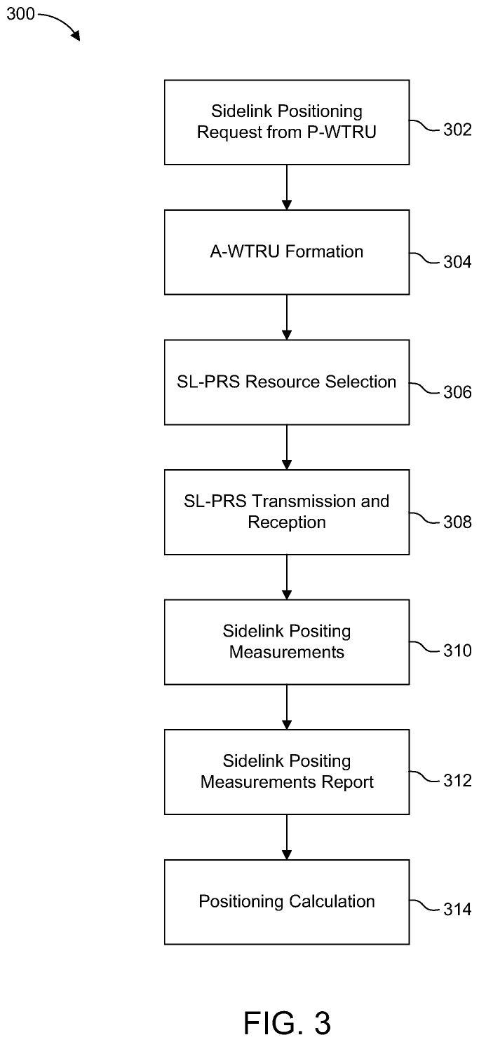

FIG. 3 is a flowchart illustrating an exemplary sidelink positioning procedure 300. A sidelink positioning procedure may include any combination of the steps in shown in FIG. 3. At 302, a WTRU receives a sidelink positioning request from another WTRU (e.g., P-WTRU) or the upper layer (e.g., RRC, NAS, MAC, or other logical equivalent) of the WTRU. At 304, one of the WTRUs (e.g., P-WTRU or A-WTRU) may initiate the A-WTRU formation procedure to support one or multiple P-WTRUs in locating its location. At 306, after a set of A-WTRUs are determined, one or more WTRUs may perform SL-PRS resource allocation. At 308, one or more WTRUs may perform SL-PRS transmission and reception. At 310, one or more WTRUs may perform sidelink measurements. At 312, a sidelink positioning measurement report is created. At 314, one entity (e.g., the network or P-WTRU) may calculate the position of the WTRU based on the obtained sidelink measurement and reporting.

Methods to determine the A-WTRUs are described herein. In some methods, a WTRU may trigger transmission of a positioning request message based on positioning triggers. For example, a WTRU (e.g., P-WTRU or A-WTRU) may trigger transmissions of a message (e.g., a positioning assistant request or a discovery message) based on one or any combination of the following triggers: when the WTRU initiates the positioning service requiring the support of sidelink communication; or when the WTRU receives the positioning request message from another node (e.g., the gNB or another WTRU).

The positioning assistant request message may be used by either P-WTRU or A-WTRU to initiate the positioning service. In one approach, the message may be initiated by a P-WTRU to initiate the service by requesting the A-WTRU to support locating the location of a P-WTRU. In some approaches, the message may be initiated by an A-WTRU to offer a positioning service to a P-WTRU. For example, the message may contain the identity of the WTRU (e.g., WTRU ID). The message may contain the identity of the positioning service (e.g., positioning service ID, destination ID). Specifically, the WTRU may be configured one or multiple IDs, each ID may be associated with one positioning service. The WTRU may then include the positioning service ID in the message based on its registered positioning service.

The message may contain positioning information of the WTRU. The positioning information of the WTRU may include its location (e.g., the absolute coordinate, the relative position to other entities, the zone information, error bound, etc.). Specifically, the WTRU may include its estimated location and potential error bound in the message. Alternatively, or additionally, the WTRU may include its zone ID in the message. The positioning information may be obtained from the last positioning session and/or from another positioning method (e.g., RAT independent methods such as GNSS). The WTRU may also indicate “unknown” location information in the message if it is not aware of its location.

The message may contain movement information of the WTRU. The movement information of the WTRU may include the speed, the heading, the lane information, etc. For example, the WTRU may include its absolute speed and/or the relative speed to another entity (e.g., another WTRU) in the message.

The message may contain QoS requirements of the positioning service. The QoS requirements of the positioning service may include the priority of the positioning service, the positioning accuracy, the latency and/or the measurement report periodicity. For example, the WTRU may be configured or pre-configured with one or more positioning QoS profiles. Each positioning may be associated with one or multiple of the above parameters. The WTRU may indicate the positioning QoS profile ID in the message to support other WTRU in determining the required QoS of the positioning service.

The message may contain serving cell information. The serving cell information may include the cell ID, the neighbor cell IDs, the group of cells involved in the positioning service, the PLMN ID, etc. For example, the WTRU may indicate the cell ID, the PLMN, etc., in the message to facilitate other WTRU in determining to become an A-WTRU or P-WTRU.

The message may contain coverage information. The coverage information may include an InC or OoC indication. For example, the WTRU may indicate whether it is in coverage or out of coverage. The WTRU may also indicate the required coverage status of the other WTRU to become an A-WTRU. For example, the WTRU may require the other WTRU to be in coverage to become an A-WTRU.

The message may contain the WTRU's RRC state information. The RRC state information may include one or any combination of the states (i.e., CONNECTED, IDLE, INACTIVE).

The message may contain the WTRU's supported positioning methods. Specifically, the WTRU may indicate which sidelink positioning methods (e.g., OTDOA, RTT, AoA, AoD, etc.) may be used.

The message may contain synchronization information. The WTRU may indicate the synchronization source it is using for transmission of the message, the time gap between synchronization reception and the transmission of the message, and/or the synchronization source it may use to reference the subsequent sidelink transmissions (e.g., SL-PRS). For example, the WTRU may indicate its transmission timing of the message (e.g., UTC timing). For example, the WTRU (e.g., P-WTRU) may indicate further information about the synchronization sources. The information may be one or more of the following: a synchronization source WTRU ID of the group; an SSID of the synchronization source; a location (e.g., coordinate, zone ID, etc.) of the synchronization source WTRU; a priority of the synchronization source; or a link quality between the WTRU and the synchronization source. For instance, the WTRU may include a Uu RSRP if the WTRU is synchronized to a network node (e.g., a gNB). In some cases, if the WTRU is synchronized to another WTRU (e.g., synchronization source WTRU), the WTRU may include an SL-SSB-RSRP measured from the SL-SSB from the synchronization source WTRU.

The message may contain the transmission power of the message.

The message may contain conditions to become an A-WTRU. Specifically, the WTRU may indicate the conditions to become an A-WTRU. The criteria may include one or any combination of the following requirements. Such requirements may include a minimum and/or maximum distance to the P-WTRU. For example, the WTRU may implicitly/explicitly indicate the maximum allowed distance to become the A-WTRU. The WTRU may include its location information in the message then the potential A-WTRU may calculate the distance between two WTRUs. It may respond to the message if the distance is smaller than the maximum distance indicated in the message.

The requirements may include a sidelink measurement. For example, the WTRU may indicate the minimum sidelink channel (e.g., SL-RSRP, SL-RSSI, SL-RSRQ) between two WTRUs to become an A-WTRU.

The requirements may include an NLOS/LOS status. For example, the WTRU may indicate whether the WTRU with certain NLOS status may be an A-WTRU.

The requirements may include coverage information, WTRU state information, and/or cell IDs. In some examples, the WTRU may require the potential A-WTRU to be in coverage. The WTRU may indicate the PLMN in the message and it may require the WTRU to be in coverage of the same PLMN. In another example, the WTRU may allow the potential A-WTRU to be either in coverage or out of coverage.

The requirements may include a WTRU state. For example, the WTRU may indicate which WTRU in which RRC status can become an A-WTRU. For example, the WTRU may require the A-WTRU to be in either INACTIVE or CONNECTED state. A potential WTRU may switch its RRC state if it determines to become an A-WTRU of the WTRU.

The requirements may include synchronization information. In some examples, the WTRU may require the A-WTRU to use the same synchronization source and/or the same SSID. In some examples, the WTRU may require an A-WTRU to synchronize to a network node (e.g., a gNB or GNSS). In another example, the WTRU may require the A-WTRU to have its synchronization source priority being larger than a threshold.

The requirements may include the supported positioning method. For example, the P-WTRU may indicate the positioning method to use. A WTRU may then determine whether to respond to the message based on whether it can support the indicated positioning method or not.

The requirements may include a positioning metric. For example, the P-WTRU may indicate whether it needs to determine its absolute positioning or its relative position.

In some embodiments, a WTRU (e.g., an A-WTRU) may determine one WTRU (including itself) to become an A-WTRU. In one such method, an A-WTRU may perform one or any combination of the following: sending a message (e.g., a positioning assistant response) in response to a position assistant message; sending a message (e.g., a positioning assistant message) to offer a positioning service to a P-WTRU; transmitting and/or receiving a SL-PRS from other WTRU; or reporting positioning measurement to the other WTRU (e.g., P-WTRU) and/or a network node (e.g., a gNB).

In some examples, a WTRU may determine whether to become an A-WTRU based on one or any combination of factors described below. In one instance, the WTRU may determine whether to become an A-WTRU based on the positioning service ID (e.g., destination ID or group ID) indicated in the positioning assistant request message.

A WTRU may determine whether to become an A-WTRU based on the WTRU's location information. For example, the WTRU may determine to become an A-WTRU if it has its location information (e.g., zone ID and/or coordinate of the location) and the location error is smaller than a threshold. Otherwise, the WTRU may not become an A-WTRU. The location error may be determined based on the last time the WTRU obtained its location and the movement characteristic of the WTRU.

A WTRU may determine whether to become an A-WTRU based on a distance to the other WTRU (e.g., the P-WTRU). Specifically, a WTRU may become an A-WTRU if the distance to the other WTRU (e.g., P-WTRU) is smaller than a threshold. The distance threshold may be configured or pre-configured per positioning service or per positioning method. Alternatively, or additionally, it may be indicated to the WTRU from another WTRU (e.g., P-WTRU) via a message (e.g., positioning assistant message).

A WTRU may determine whether to become an A-WTRU based on movement information of the WTRU. A WTRU may determine to become an A-WTRU of a P-WTRU based on the movement information of the P-WTRU and/or the A-WTRU. In one example, the WTRU may determine to become an A-WTRU if the relative speed between itself and the P-WTRU is smaller than a threshold. In some examples, the WTRU may determine to become an A-WTRU if its relative speed is smaller than a threshold and the speed of each WTRU is smaller than another threshold.

A WTRU may determine whether to become an A-WTRU based on QoS requirements of the positioning service. For example, the WTRU may be configured or pre-configured to support a certain level of QoS requirements. The WTRU may determine to become an A-WTRU if it can satisfy the QoS requirements (e.g., QoS profile) indicated in the positioning assistant request message.

A WTRU may determine whether to become an A-WTRU based on a sidelink requirement to assist in locating the positioning of the WTRU. Specifically, a WTRU may determine to become an A-WTRU based on the sidelink measurement between the WTRU and the P-WTRU. For example, the WTRU may become an A-WTRU if sidelink measurement (e.g., SL-RSRP, SL-RSSI, SL-RSRQ) between itself and the other WTRU (e.g., P-WTRU) is larger than a threshold. The sidelink measurement may be measured on the transmissions of the positioning assistant request message from the P-WTRU. The sidelink measurement threshold may be configured per resource pool, positioning service, or it may be indicated by another WTRU (e.g., P-WTRU). The sidelink measurement threshold may be a function of distance between two WTRUs.

A WTRU may determine whether to become an A-WTRU based on LOS/N LOS detection. A WTRU may determine to become an A-WTRU based on the LOS/NLOS status between itself and the other WTRU (e.g., the other A-WTRU or the P-WTRU). For example, the WTRU may become an A-WTRU if the sidelink between itself and the P-WTRU is LOS. Otherwise, it may not become an A-WTRU. The WTRU may detect the LOS/NLOS based on the combination of sidelink measurement (e.g., SL-RSRP, SL-RSRQ, RSSI) and/or the distance between two WTRUs. Specifically, if the SL-RSRP of the link between two WTRU is smaller than a threshold, it may consider the link as LOS; otherwise, it may consider the link as NLOS. The SL-RSRP threshold may be a function of the distance between two WTRUs. The WTRU may also detect the LOS/NLOS based on statistics (e.g. variance, average) of received power or amplitude in frequency domain over a specific bandwidth for a signal received from the other WTRU.

A WTRU may determine to become an A-WTRU based on serving cell information of itself and the P-WTRU. In one example, the WTRU may determine to become an A-WTRU if its serving cell is the same as that of the P-WTRU. In some examples, the WTRU may determine to become an A-WTRU if it has the same PLMN as the P-WTRU. The PLMN of the P-WTRU may be indicated to the WTRU by the positioning assistant request message. In some examples, the WTRU may determine to become an A-WTRU if its current serving cell belongs to a set of cells, which may be indicated by the P-WTRU in the positioning assistant request message. If the current serving cell of the WTRU does not belong to the set of cells, the WTRU may request the current serving cell to handover to one of the cells in the set. If the WTRU does not have a serving cell, the WTRU may perform initial access to one of the cells in the set of cell IDs to become an A-WTRU of the P-WTRU.

A WTRU may determine whether to become an A-WTRU based on the WTRU's supported positioning methods. An A-WTRU may determine to become an A-WTRU if at least one of its supported positioning methods belong to the set of the method requested by the other WTRU (e.g., P-WTRU). For example, the P-WTRU may request an AoA or AoD method. The WTRU may determine to become an A-WTRU if it supports one of the methods (AoA or AoD). Otherwise, it may not become an A-WTRU.

A WTRU may determine whether to become an A-WTRU based on synchronization information of the WTRU and/or another WTRU (e.g., P-WTRU). For example, the WTRU may determine to become an A-WTRU if it synchronizes to a high priority synchronization source (e.g., GNSS and/or gNB or another network node). For example, the WTRU may determine to become an A-WTRU if it uses the same synchronization source as the P-WTRU. For example, the WTRU may determine to become an A-WTRU if its original synchronization source is the same as the one from the P-WTRU. For example, if the P-WTRU is synchronized to a gNB, the WTRU may determine to become a A-WTRU if it is synchronized to the gNB. Alternatively, if the P-WTRU is synchronized to GNSS, the A-WTRU may determine to become an A-WTRU if it is synchronized to GNSS. In some cases, the WTRU may determine to become an A-WTRU if it is synchronized to a synchronization source with higher or equal priority compared to the synchronization source of the P-WTRU.

A WTRU may determine whether to become an A-WTRU based on a maximum number of supported P-WTRUs. The WTRU may determine to become an A-WTRU of a P-WTRU based on the maximum number of supported P-WTRUs. Specifically, the WTRU may be configured or pre-configured to support a maximum number of P-WTRUs. The WTRU may then determine whether to support another P-WTRU based on the number of WTRUs it is supporting.

A WTRU may determine whether to become an A-WTRU based on the CBR of the resource pool, the load of the WTRU, and/or the CR of the WTRU. For example, the WTRU may determine to become an A-WTRU if the CBR of the resource pool is smaller than a threshold and/or load of the WTRU is smaller than another threshold, and/or the CR of the WTRU is smaller than a threshold.

A WTRU may determine whether to become an A-WTRU based on a positioning metric (e.g., absolute positioning vs. relative positioning). For example, the WTRU may determine whether it can be an A-WTRU or not based on the required positioning metric. Specifically, the WTRU may determine not to become an A-WTRU if the P-WTRU wants to obtain absolute positioning; however, the WTRU may determine to become an A-WTRU if the P-WTRU wants to obtain relative positioning.

A WTRU may determine whether to become an A-WTRU based on the coverage status. The WTRU may determine to become an A-WTRU of the P-WTRU based on its coverage status. For example, for absolute positioning, a WTRU may determine to become an A-WTRU if it is in the network coverage. In some cases, the WTRU may determine not to become an A-WTRU. For relative positioning, the WTRU may determine to become a A-WTRU regardless of the coverage status.

A WTRU may determine whether to become an A-WTRU based on a Uu RSRP. In some examples, the WTRU may determine to become an A-WTRU if a Uu RSRP is larger than a threshold. In some cases, the WTRU may determine not to become an A-WTRU. In some examples, the WTRU may determine to become an A-WTRU if Uu RSRP is smaller than a threshold. Otherwise, the WTRU may determine not to become an A-WTRU.

A WTRU may determine to become an A-WTRU based on the distance to the P-WTRU and the sidelink measurement. Specifically, the WTRU may become an A-WTRU if the distance between two WTRUs is smaller than a threshold and the SL-RSRP is larger than a threshold. In another example, the WTRU may determine to become an A-WTRU based on the LOS/NLOS indication and the distance to the P-WTRU. Specifically, the WTRU may not become an A-WTRU if the link between itself and the other WTRU (e.g., P-WTRU) is NLOS.

In some embodiments, a WTRU may indicate positioning related information in the positioning assistant response message. For instance, the WTRU (e.g., A-WTRU) may send a response message to another node (e.g., P-WTRU or gNB) to support the node in determining the set of A-WTRUs. The response message may include one or any combination of the following: the WTRU's location information (e.g., zone-id, GPS); distance to another WTRU (e.g., the P-WTRU); movement information of the WTRU; QoS requirements of the positioning service; or a sidelink measurement to other WTRU (e.g., P-WTRU). For example, the WTRU may indicate SL-RSRP, SL-RSSI, or SL-RSRQ of the sidelink with the P-WTRU in the response message.

The response message may include LOS/NLOS detection. For example, the WTRU may indicate whether the link between itself is LOS or NLOS.

The response message may include one or any combination of the following: the serving cell information, by which, for example, the WTRU may indicate the Cell ID and PLMN ID; the WTRU's supported positioning methods; synchronization information, by which, for example, the WTRU may indicate which synchronization source (e.g., gNB or another network node, GNSS, reference WTRUs, etc.) the WTRU is using; the Uu RSRP of the current cell (e.g., when WTRU is in the network coverage, the WTRU may indicate the measured Uu RSRP of the current cell); a cell coverage status of the WTRU (e.g., the WTRU may indicate whether the WTRU is in coverage or out of coverage); a SL-SSB-RSRP (e.g., if the WTRU is synchronized to another WTRU, the WTRU may include the RSRP measured in the SL-SSB (i.e., SL-SSB-RSRP); or the maximum number of supported P-WTRUs, the CBR of the resource pool, the load of the WTRU, and/or CR of the WTRU.

A WTRU may determine whether a WTRU can be an A-WTRU. In some embodiments, a WTRU (e.g., P-WTRU) may collect the message from one or multiple WTRUs and then determine whether each of the WTRUs can be an A-WTRU based on one or any combination of factors. Factors may include the relative distance between the WTRU and the P-WTRU. For example, the WTRU may determine a certain WTRU to become an A-WTRU if it is within a distance range from the P-WTRU.

Factors may include the change of relative distance with the P-WTRU. For example, the P-WTRU may determine a WTRU to be an A-WTRU if the change in the relative distance between the P-WTRU and the candidate A-WTRU is smaller than a threshold. For example, the WTRU may be configured or preconfigured with a period to determine whether one WTRU can be an A-WTRU. The WTRU may measure the change of relative distance between two devices to determine whether the candidate device can be an A-WTRU or not. If the change in the relative distance between two devices is smaller than a threshold, the candidate WTRU may be selected as an A-WTRU. In some instances, the candidate WTRU may not be an A-WTRU. The threshold of relative distance change may be configured by LMF or preconfigured, which may further depend on the QoS requirement of the positioning service.

Factors may include QoS requirements of the positioning service. For example, the P-WTRU may determine whether one candidate WTRU can be an A-WTRU based on QoS requirement of the positioning service. Specifically, for one QoS requirement, the WTRU may determine one candidate WTRU to be an A-WTRU; however, for a more stringent QoS requirement (e.g., for a more accuracy requirement or a faster positioning update), the P-WTRU may determine the WTRU not to be an A-WTRU.

Factors may include sidelink measurements to other WTRU (e.g., P-WTRU). For example, the WTRU may be configured or preconfigured with an SL-RSRP range, in which a candidate WTRU can be an A-WTRU if sidelink channel between two WTRUs is within the range. In some cases, the P-WTRU may determine the candidate WTRU not to become an A-WTRU. The SL-RSRP thresholds may be configured or preconfigured per positioning service and possibly per positioning QoS requirement.

Factors may include LOS/NLOS detection. For example, the P-WTRU may determine that one candidate WTRU can be an A-WTRU if it has LOS channel with the P-WTRU. In some cases, the P-WTRU may determine that the candidate WTRU cannot be an A-WTRU.

Factors may include the serving cell information. For example, a candidate WTRU may indicate its cell ID and possibly its PLMN ID. In some approaches, the WTRU may determine the candidate WTRU to become an A-WTRU if they are camping in the same cell. In some approaches, the WTRU may determine the candidate WTRU to become an A-WTRU if they belong to the same PLMN ID.

Factors may include the WTRU's supported positioning methods. For example, the candidate WTRU may indicate its supported positioning method. Then the P-WTRU may determine whether the supported positioning methods of the candidate WTRU can be used to determine the positioning of the P-WTRU. If the P-WTRU determines to use one of the supported positioning methods to determine the position of the WTRU, it may consider the candidate WTRU as an A-WTRU; otherwise, it may not consider the candidate WTRU as an A-WTRU.

Factors may include the synchronization information. For example, the candidate WTRU may indicate which synchronization source (e.g., gNB or another network node, GNSS, reference WTRUs, etc.) the WTRU is using. The P-WTRU may determine whether the candidate WTRU can be an A-WTRU or not based on the synchronization source of the P-WTRU and the candidate WTRU. For example, if they are using the same synchronization source, the P-WTRU may determine the candidate WTRU to be an A-WTRU. In some cases, if they are using different type of synchronization source (e.g., P-WTRU is using a network node such as a gNB as a synchronization source and the candidate WTRU is using GNSS as the synchronization source), the WTRU may determine the candidate WTRU not to be an A-WTRU.

Factors may include the Uu RSRP of the current cell. For example, if the WTRU is in the network coverage, the WTRU may indicate the measured Uu RSRP of the current cell. The P-WTRU may determine whether the candidate WTRU can be an A-WTRU based on the indicated Uu RSRP. Specifically, the P-WTRU may determine to select a certain number of candidate WTRUs as its A-WTRUs based on its Uu RSRP. In some cases, the P-WTRU may be configured or preconfigured with a Uu RSRP range to determine whether a WTRU can be an A-WTRU. For example, the P-WTRU may select the certain number of WTRUs which has highest Uu RSRP. If the Uu RSRP of the candidate WTRU is within the configured or preconfigured range, the WTRU may be an A-WTRU; in some cases, the WTRU may not be an A-WTRU.

Factors may include a cell coverage status of the WTRU. For example, if the P-WTRU is in coverage, the WTRU may select the candidate WTRU to be in coverage of the same cell or the same PLMN. In some cases, if the P-WTRU is out of coverage, the WTRU may select a candidate WTRU as an A-WTRU regardless of the coverage status.

Factors may include a priority of the synchronization source. For example, the P-WTRU may be configured or preconfigured to select the candidate WTRU as an A-WTRU based on the priority of the synchronization source. The WTRU may then select a certain number of candidate WTRUs to become an A-WTRU based on the priority of the synchronization source indicated in the message sent to the P-WTRU.

Factors may include an SL-SSB-RSRP. For example, if the candidate WTRU is synchronized to another WTRU, the WTRU may include the RSRP measured in the SL-SSB (i.e., SL-SSB-RSRP). The P-WTRU may determine which candidate WTRU to become an A-WTRU based on the SL-SSB-RSRP provided in the message sent to the P-WTRU.

In some methods, a WTRU may determine the set of A-WTRUs. In one such method, a WTRU (e.g., P-WTRU) may determine the set of A-WTRUs based on one or any combination of the following: positioning information of the WTRU; movement information of the WTRU; QoS requirements of the positioning service; a sidelink requirement to assist in locating the positioning of the WTRU; serving cell information; coverage information; WTRU state information; the WTRU's supported positioning methods; synchronization information; a CBR of the resource pool, load of the WTRU and/or CR of the WTRU; or the connection status with the WTRU. For example, the WTRU may prioritize the WTRU having existing connection to itself. For example, the WTRU may prioritize the WTRU having the existing unicast/groupcast session to itself to become the A-WTRUs.

In some methods, a WTRU (e.g., P-WTRU) may determine the number of A-WTRUs to locate the positioning of a P-WTRU. The number of A-WTRU may be determined based on the QoS requirements of the positioning service. The WTRU may require a large number of A-WTRUs for high positioning accuracy requirements and it may require a smaller number of A-WTRUs for low positioning accuracy requirements. The number of A-WTRUs may be based on the number of TRPs involving in the positioning procedure of the WTRU. Specifically, the WTRU may require more A-WTRUs when the number of TRPs is small and it may require less A-WTRU when the number of TRPs is large.

In some methods, the WTRU may be configured or pre-configured to know which WTRU to prioritize as an A-WTRU. Specifically, the WTRU may select a WTRU as an A-WTRU if the WTRU satisfies the condition or conditions of one or multiple parameters. For example, the WTRU may consider one WTRU as a possible A-WTRU if it satisfies one or any combination of the following conditions: the location error bound of the WTRU is smaller than an error threshold; the distance to the P-WTRU is smaller than a threshold and/or larger than another threshold; the speed of the WTRU is smaller than a threshold and/or the relative speed between the WTRU and the P-WTRU is smaller than a threshold; the SL-RSRP is larger than a threshold; the WTRU has an LOS link to the P-WTRU and/or other A-WTRUs; the synchronization sources of the A-WTRU (e.g., the synchronization source of the WTRU is greater than a threshold, the number of hops to reach the original synchronization source is smaller than a threshold, or the synchronization source of the WTRU is a network node such as a gNB or a GNSS); or the coverage status of the A-WTRU (e.g., whether the WTRU is in coverage, or whether a Uu RSRP is within a range).

If the number of potential A-WTRUs is greater than the required number of A-WTRUs, the WTRU (e.g., P-WTRU) may further down select the WTRUs based on a predefined rule. For example, among all WTRU satisfying the condition or conditions of the parameter or parameters, the WTRU may select the set of WTRUs with the highest SL-RSRP. In another example, the WTRU may prioritize the WTRUs having existing connections to itself (e.g., existing unicast/groupcast session). In another example, the WTRU may select the set of WTRUs with the lowest error bound. The WTRU also may select the set of WTRUs with the lowest distance.

In one embodiment, a WTRU (e.g., P-WTRU) may broadcast a message to indicate the set of A-WTRUs to support positioning procedure to a P-WTRU. The WTRU may first include the IDs of each WTRU in the message. The WTRU may then generate an L2 ID to represent the group positioning. The ID may be then conveyed to the WTRUs in the group.

In another embodiment, a WTRU may use the L2 ID to perform group sidelink positioning procedure. Specifically, the WTRU may include the L2 ID in the message to request other WTRUs to perform SL-PRS transmission/reception and/or sidelink positioning measurement reporting. The WTRU may include the L2 ID in a transmission associated with its SL-PRS transmission. This approach may be used for other WTRUs in the group to determine whether the message is used for group positioning or not.

In another embodiment, a WTRU (e.g., A-WTRU) may monitor a sidelink resource pool to decode SCI. The WTRU may then then decode an SCI having an indicated L2-ID conveyed before. The WTRU may then perform SL-PRS transmission/reception and/or sidelink positioning measurement reporting to support positioning of the P-WTRU.

In some embodiments, a WTRU may report sidelink positioning measurements to the network. For example, in some methods, the WTRU may report the set response WTRUs and the associated information to the network (e.g., gNB or LMF) (e.g., SL-RSRP, positioning information, synchronization information, etc.) to support the network in determining the set of A-WTRUs. The WTRU may be configured or pre-configured with a set of conditions to report a response A-WTRU. Specifically, the WTRU may report the response WTRU to the network node (e.g., gNB) if it satisfies one or any combination of several conditions. For instance, the WTRU may report the response WTRU to the network node (e.g., gNB) if the link between the WTRU and the response WTRU is LOS. The LOS/NLOS indication may be detected by the reporting WTRU and/or it may be indicated by the response WTRU in the positioning assistant response message. The WTRU may report the response WTRU to the network node (e.g., gNB) if a sidelink measurement (e.g., SL-RSRP, SL-RSSI, SL-RSRQ) between the WTRU and the response WTRU is greater than a threshold. The WTRU may report the response WTRU to the network node (e.g., gNB) if the distance between two WTRUs is smaller than a threshold and/or larger than another threshold.

In some examples, the WTRU may be further configured with a maximum number of potential A-WTRUs to be reported. It may be configured with the thresholds (e.g., SL-RSRP threshold, distance threshold) to report the set of response WTRUs. This approach may be used to reduce the number of potential WTRUs to be reported to the network.

In some methods a WTRU may update the set of A-WTRUs. A WTRU (e.g., P-WTRU) may update the set of WTRUs in the group for positioning. The WTRU may perform one or any of the following procedures to add/remove one or multiple A-WTRUs and/or P-WTRUs. For example, the WTRU may report the sidelink positioning measurement to the network to support the network in determining the set of A-WTRUs. The WTRU may send the set of updated A-WTRUs and/or SL-PRS configuration and reporting. The WTRU may reconfigure the SL-PRS resource assignment and reporting.

A WTRU may remove one WTRU (including itself) from the set of A-WTRUs or add one WTRU to the set of A-WTRUs based on one or any combination of parameters or conditions. For example, the WTRU may remove or add a WTRU to the set of A-WTRUs based on positioning information of the WTRU. For example, if the positioning accuracy of the WTRU becomes worse than a threshold. The WTRU may report to another entity (e.g., gNB, P-WTRU, or other WTRU) and/or exclude itself from the list of A-WTRUs.

The WTRU may remove or add a WTRU to the set of A-WTRUs based on positioning information of the WTRU. The WTRU may remove or add a WTRU to the set of A-WTRUs based on the distance between the A-WTRU and other WTRU (e.g., P-WTRU). For example, a WTRU (e.g., P-WTRU) may add one WTRU in the set of A-WTRUs if the distance between itself and the A-WTRU become smaller than a threshold. Alternatively, or additionally, the WTRU may remove one A-WTRU in the set of A-WTRUs if the distance between itself and the A-WTRU become larger than another threshold. The distance threshold may be configured by a network node such as a gNB or LFM. Alternatively, or additionally, the thresholds may be configured or preconfigured per positioning service.

The WTRU may remove or add a WTRU to the set of A-WTRUs based on movement information of the WTRU. The WTRU may remove or add a WTRU to the set of A-WTRUs based on sidelink measurement. For example, a WTRU (e.g., P-WTRU) may remove another WTRU from the set of A-WTRUs if it detects a RLF for the link between two WTRU and/or SL-RSRP of the link between two WTRUs becomes larger than a threshold. For example, a WTRU (e.g., P-WTRU) may add one WTRU to the set of A-WTRUs if it detects a certain SL-RSRP.

The WTRU may remove or add a WTRU to the set of A-WTRUs based on a LOS/N LOS of a link between the WTRU and the other WTRU (e.g., P-WTRU). For example, the WTRU (e.g., P-WTRU) may determine to remove a WTRU from a set of A-WTRUs if it detects that the channel between the P-WTRU and the A-WTRU has NLOS. Alternatively, or additionally, the WTRU may then add one WTRU into the set of A-WTRUs if it detects that the channel between the WTRU and the P-WTRU as LOS.

The WTRU may remove or add a WTRU to the set of A-WTRUs based on synchronization information. The WTRU may remove or add a WTRU to the set of A-WTRUs based on CBR of the resource pool, load of the WTRU and/or CR of the WTRU. The WTRU may remove or add a WTRU to the set of A-WTRUs based on a connection status with the WTRU. For example, a node (e.g., P-WTRU or gNB) may include a WTRU to a set of A-WTRUs if it establishes a unicast/groupcast link with the WTRU.

The WTRU may remove or add a WTRU to the set of A-WTRUs based on the sidelink positioning measurement reporting accuracy. For example, a node (e.g., P-WTRU or gNB) may exclude a WTRU from the set of A-WTRU if the sidelink positioning measurement report of one or multiple parameters is not within an expected range and/or the WTRU has not reported sidelink positioning measurement in one or multiple reporting occasions.

In some methods, a WTRU may determine a positioning method and reporting configuration. For example, the WTRU may determine the positioning method and the associated reporting parameters for one or multiple WTRU. Specifically, the WTRU may determine one or any combination of the following: the positioning method (e.g., carrier phase-based positioning method, OTDOA, AoA, AoD, RTT, and any combination of these methods); the sidelink positioning measurement reporting (RSTD, T_(Rx-Tx) (the time gap between PRS transmission and reception), AoA, AoD, ToA, ToD, SL-RSRP, SL-RSRQ, SL-RSSI, etc.); the set of WTRU transmitting SL-PRSs and/or the set of WTRU receiving SL-PRS; or the set of WTRU transmitting and receiving SL-PRS.

With regards to the carrier phase-based positioning method, a WTRU may measure the phase of arrival (PoA) of a SL-PRS transmission, difference between PoA (DPoA) to determine help determine the position of the WTRU.

Such a decision may be determined based on one or any combination of parameters or conditions. The decision may be based on a configuration or pre-configuration. The decision may be based on synchronization information of the WTRUs in the group. For example, the WTRU may require the high priority synchronization source (e.g., GNSS or gNB) WTRUs to perform SL-PRS transmission or reception and low priority synchronization source WTRU to perform SL-PRS transmission and reception. For example, the WTRU may use angle-based method (e.g., AoA, AoD) if the synchronization accuracy among the WTRUs in the group is low and the WTRU may use a time-based method (e.g., OTDOA) if the synchronization accuracy among WTRUs in the group is high. The synchronization accuracy may be determined based on the synchronization source (e.g., the priority of the synchronization source and/or the sidelink measurement of the synchronization signals).

The decision may be based on QoS requirements of the positioning service. For example, the WTRU may use the SL-PRS transmission or SL-PRS reception-based method for low latency positioning service and the WTRU may use the SL-PRS transmission and reception-based method for latency tolerant positioning services.

The decision may be based on the distance between two WTRUs. For example, a WTRU may determine which positioning method to use based on the distance between itself and a A-WTRU (e.g., the furthest WTRU). For example, the WTRU may select the angle method (e.g., AoA or AoD) if the distance between the P-WTRU and the furthest WTRU is greater than a threshold; otherwise, the WTRU may use a timing-based method.

The decision may be based on coverage information and/or WTRU state information. For example, the WTRU may use the SL-PRS transmission-based (i.e., P-WTRU performs SL-PRS transmission) or SL-PRS reception-based (P-WTRU performs SL-PRS reception) method if all WTRUs are within the cell coverage. This approach may be used to reduce the amount of SL-PRS transmission. For example, the WTRU (e.g., P-WTRU) may require the out of in coverage WTRUs to perform SL-PRS transmission or reception and out of coverage WTRUs to perform SL-PRS transmission and reception.

The decision may be based on a CBR of the resource pool, the load of the WTRU and/or CR of the WTRU.

The decision may be based on the availability of the synchronization offset among WTRUs in the group. For example, the WTRU may perform RTT, AoA, or AoD method if the WTRU does not have synchronization offset to another A-WTRU within a period. Otherwise, if the WTRU has all the synchronization offset for other A-WTRUs in the group, the WTRU may use a OTDOA, or TDOA method.

The decision may be based on whether the output is relative or absolute position.

The decision may be based on the current position error of the P-WTRU. Specifically, the WTRU may determine which position method to use based on the current position error of the WTRU. Specifically, if the current position error of the WTRU is smaller than a threshold, the WTRU may use a carrier phase-based method. Otherwise, the WTRU may use other positioning method.

In one example, the WTRU may combine multiple positioning methods in one position procedure. For example, for a group of A-WTRUs, the WTRU may perform both TOA, and RTT methods, in which, the WTRU may require one WTRU to both transmit and receive SL-PRS if the WTRU does not have synchronization offset information of the WTRU. However, the WTRU may perform a time of arrival (ToA) method, in which the WTRU may require the WTRU to transmit or receive SL-PRS if the WTRU have synchronization offset information of the WTRU.

In another example, the WTRU may perform different synchronization methods in different phase to obtain the highest position accuracy. For example, in the first interval, the WTRU may first perform one position method such as angle method to obtain the first level of positioning accuracy. The WTRU may then, in the second interval, perform another position method such as carrier-phase based method to obtain the second level positioning accuracy.

In another example, the WTRU may perform multiple positioning methods simultaneously. Specifically, the WTRU may perform timing-based method and carrier-phase based method to help determining the position of the WTRU. Specifically, the WTRU may perform SL-PRS transmission/reception. The WTRU may then require A-WTRUs to perform both phase and time measurement and report the position measurement result to the WTRU or the network. The WTRU may determine whether to use multiple positioning method simultaneously based on the positioning accuracy requirement and/or the latency requirement of the positioning service.

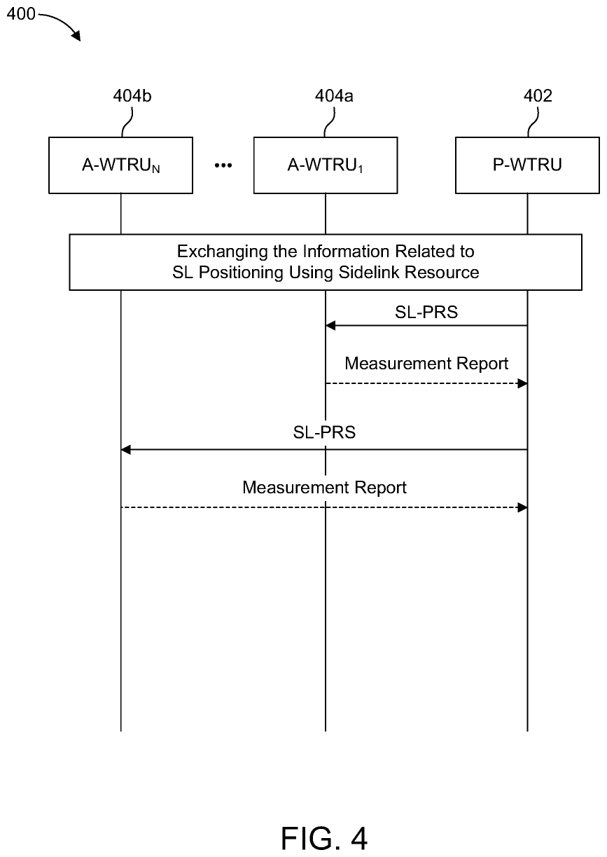

FIG. 4 illustrates an exemplary signaling flow 400 in which a P-WTRU 402 transmits SL-PRS all A-WTRUs 404a and 404b, which receive the SL-PRS transmission (e.g., an SL-PRS transmission-based method). As shown in FIG. 4, the WTRU may select a P-WTRU to transmit SL-PRSs and one or more A-WTRU to receive the SL-PRS and perform sidelink positioning measurement.

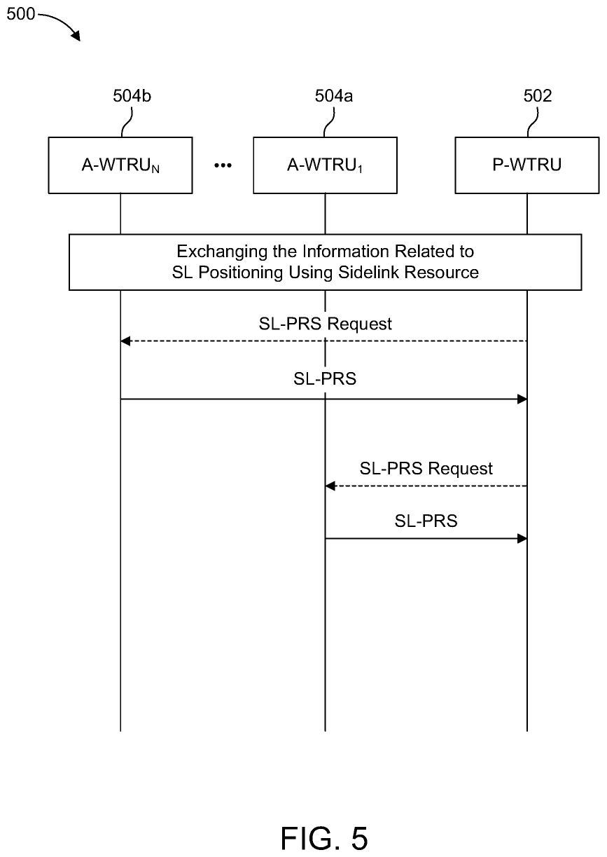

FIG. 5 illustrates an exemplary signaling flow 500 in which all A-WTRUs 504a and 504b transmit SL-PRS to the P-WTRU (SL-PRS transmission-based method). As illustrated in FIG. 5, the WTRU may select all A-WTRUs to transmit SL-PRSs and the P-WTRU to receive SL-PRS and perform sidelink positioning measurement.

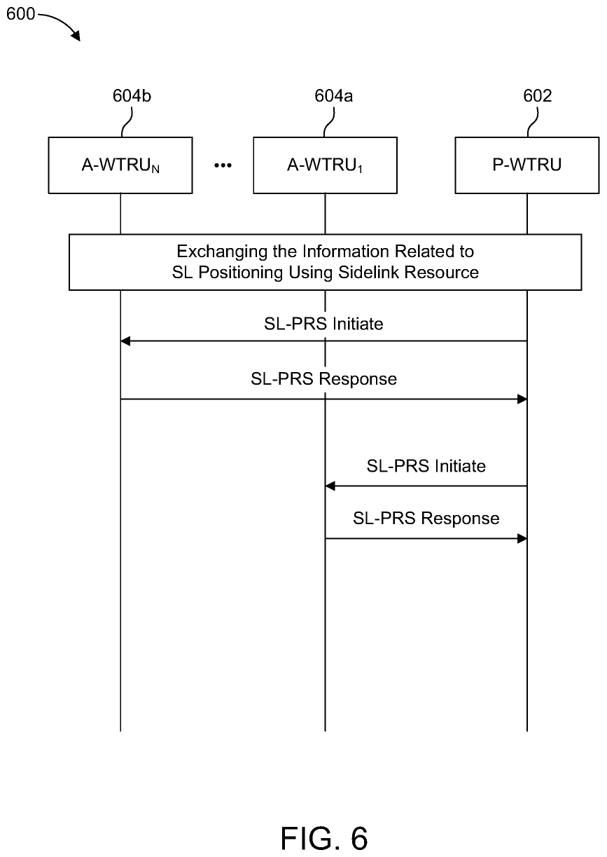

FIG. 6 illustrates an exemplary signaling flow 600 in which all WTRUs transmit/receive SL-PRS (SL-PRS transmission and reception-based method). As shown, the WTRU may select all WTRUs (both P-WTRU and A-WTRU) to transmit and receive SL-PRS. In some methods, the WTRU may select one set of WTRUs performing SL-PRS transmission, another set of WTRUs performing SL-PRS reception, and another set of WTRUs performing SL-PRS transmission and reception.

Methods for synchronization are described herein. In some methods, a WTRU may transmit a sidelink positioning synchronization signal for a group of WTRUs. In one such example, a WTRU may transmit a synchronization signal for a group of WTRUs to synchronize the transmission timing of the WTRUs in the group. The WTRU may use one or any of the following as a sidelink synchronization signal: an SL-PRS; an SLSS (S-PSS, S-SSS); a DMRS; a PTRS; a CSI-RS; or a new signal designed for positioning synchronization.

A WTRU (e.g., P-WTRU or A-WTRUs in the group) may use the timing of the sidelink positioning synchronization signal to perform one or any combination of the following procedures. For example, the WTRU may use the timing of the positioning synchronization signal to perform sidelink positioning measurement. Specifically, the WTRU may still use the timing of the normal sidelink synchronization procedure to derive its transmission and reception timing. However, the WTRU may use the timing of the positioning synchronization signal to derive the measurement (e.g., RSTD, ToA). The WTRU may report the offset between its normal sidelink synchronization timing and the positioning synchronization timing to support other WTRU in performing sidelink measurement (e.g., RSTD).

The WTRU may use the timing of the positioning synchronization signal to use a reference time to perform other transmissions such as SL-PRS and data transmission. Specifically, the WTRU may use the sidelink positioning synchronization signal to derive the positioning Direct Frame Number (DFN) timing. In some approaches, the WTRU may use the positioning DFN to transmit and receive all sidelink transmissions. In some approaches, the WTRU may use the positioning DFN to transmit SL-PRS and other positioning synchronization signal. It may the use normal sidelink DFN, which may be derived from the normal sidelink transmission to transmit and receive sidelink data.

In some methods, a WTRU may be configured with multiple positioning synchronization types. In one such method, the WTRU may be configured or pre-configured to transmit and/or receive one or multiple positioning synchronization types. Each type may be associated with one or any combination of the following. For instance, each type may be associated a reference signal used for the synchronization transmission. For example, the first positioning synchronization type may use DMRS of PSSCH and/or PSCCH. The second positioning synchronization type may use SL-CSI-RS, and the third positioning synchronization type may use a new signal designed for positioning synchronization.

Each type may be associated with the resources used for a positioning synchronization transmission. Specifically, one synchronization type may use one set of resources which may include the number of subchannels for each transmission, the RS pattern, the number of repetitions, the region of the resource, etc.

For example, the first positioning synchronization type may use a configure or pre-configured resources for a normal sidelink transmission, and the second positioning synchronization type may use a configured or pre-configured resource for synchronization of positioning purposes only.

In some examples, the WTRU may be configure or pre-configured with two positioning synchronization types. The first positioning synchronization type may use the DMRS of PSSCH and/or PSCCH. The resource for the first positioning synchronization type may be dynamically selected by the WTRU or scheduled by the network. The second positioning synchronization type may use a new signal designed for positioning synchronization. The resource for the second positioning synchronization type may be configured or pre-configured per resource pool and/or per carrier.

In some methods, a WTRU may determine the positioning synchronization type. The WTRU may determine which positioning synchronization type to use for transmission and/or reception based on one or any combination of the following parameters or conditions. For example, the WTRU may determine which positioning synchronization type to use when WTRU receives the positioning synchronization request from another node (e.g., a WTRU or gNB). For instance, the WTRU may receive a positioning synchronization transmission request from the peer WTRU, which may have an existing unicast session and PC5 RRC connection with the WTRU. The message may indicate which positioning synchronization type is requested. The WTRU may transmit the positioning synchronization type as requested.

The WTRU may determine which positioning synchronization type to use based on QoS requirements of the positioning service. For example, the WTRU may use the first positioning synchronization type (e.g., the synchronization using DMRS of PSSCH and/or PSCCH) if the positioning service requires low positioning accuracy. Alternatively, or additionally, the WTRU may use the third positioning synchronization type (e.g., the positioning synchronization using a new signal designed for positioning) if the positioning service requires high positioning accuracy.

The WTRU may determine which positioning synchronization type to use based on a CBR of the resource pool and/or CR of the WTRU. For example, the WTRU may use the first positioning synchronization type if the CBR of the resource pool and/or CR of the WTRU is greater than a threshold. This approach may be used to reduce the number of sidelink transmissions and reduce the congestion for the resource pool.

The WTRU may determine which positioning synchronization type to use based on positioning information and/or movement information of the WTRU. For example, the WTRU may use the first positioning synchronization type if the positioning error of the WTRU is smaller than a threshold and it may use the second positioning synchronization type if the positioning error of the WTRU is larger than a threshold.

The WTRU may determine which positioning synchronization type to use based on a distance from one WTRU (e.g., P-WTRU) to another WTRU (e.g., an A-WTRU). For example, the WTRU may use the positioning synchronization type if the distance between two WTRUs in the group is within one range and it may use the second positioning synchronization type if the distance between two WTRUs in the group is within another range.

Alternatively, or additionally, the WTRU may determine which positioning synchronization type to use based on: a sidelink measurement between two WTRUs in the group; or the coverage information and/or the WTRU state information. For example, a group of WTRUs may use the first synchronization type (e.g., SL-PRS DMRS) if all WTRUs are in the coverage of the same network node (e.g., gNB) or the same PLMN. If the group of WTRUs are out of coverage or partial coverage, the P-WTRU may determine to use the second synchronization type (e.g., new signal designed for positioning synchronization).

The WTRU may determine which positioning synchronization type to use based on the positioning method used in the group. For example, the WTRU may use the first positioning synchronization type for angle-based methods (e.g., AoA, AoD), and it may use the second positioning synchronization type for timing-based methods (e.g., OTDOA).

The WTRU may determine which positioning synchronization type to use based on the synchronization source used to reference a synchronization signal.

In some methods, a WTRU may determine whether a group of WTRUs requires a WTRU to transmit positioning synchronization signals. In some such solutions, a group of WTRUs may require a WTRU to transmit positioning synchronization signals to synchronize the transmission timing of the WTRUs in the group and/or support the WTRUs in performing sidelink measurement. In some solutions, the group of WTRUs may use the synchronization source from other entities which may not belong to the group (e.g., other WTRU, gNB, and/or GNSS). A WTRU (e.g., P-WTRU) may determine whether to assign a WTRU to become a positioning synchronization source for a group of WTRUs by transmitting synchronization signals based on one or any combination of parameters or conditions.

For instance, a WTRU (e.g., P-WTRU) may determine whether to assign a WTRU to become a positioning synchronization source for a group of WTRUs based on the coverage status and/or the RRC status of the WTRUs in the group. For example, the group may not require a WTRU to transmit positioning synchronization signals if all WTRUs are in the network coverage (InC). The WTRUs in the group may use the downlink timing of the network node (e.g., gNB) to synchronize sidelink transmission timing. A WTRU (e.g., A-WTRU) may report the timing advance (TA) information to other WTRU (e.g., P-WTRU) to support the WTRU in the sidelink measurement reporting. For example, the group may require one WTRU to transmit positioning synchronization signals if multiple WTRUs are out of network coverage (OoC). This approach may be motivated to synchronize the transmission timing of InC and OoC WTRUs. For example, if one WTRU is OoC and all other WTRU are InC, the network may or may not require one WTRU to transmit positioning synchronization signals.

A WTRU (e.g., P-WTRU) may determine whether to assign a WTRU to become a positioning synchronization source for a group of WTRUs based on synchronization information of each WTRU in the group. For example, the group may not require one WTRU to transmit synchronization signals if all WTRUs in the group are synchronized to one synchronization source (e.g., GNSS, one gNB, or one SSID). For example, the WTRU may require one WTRU (e.g., P-WTRU) to transmit synchronization signal to the group one WTRU in the group (e.g., A-WTRU or P-WTRU) is directly/indirectly synchronized to GNSS.

For example, the group may require one WTRU to transmit synchronization signals if the WTRUs in the group use different synchronization sources. Specifically, if one set of the WTRUs use one synchronization source and the other set of the WTRUs use another synchronization source, the group may require one WTRU to transmit positioning synchronization signals to synchronize the WTRUs in the group.

A WTRU (e.g., P-WTRU) may determine whether to assign a WTRU to become a positioning synchronization source for a group of WTRUs based on QoS requirements of the positioning service. For example, the group may not require one WTRU to transmit positioning synchronization signals if the positioning accuracy requirement is smaller than a threshold. The group may require one WTRU to transmit positioning synchronization signals if the accuracy requirement of the positioning service is larger than a threshold.

A WTRU (e.g., P-WTRU) may determine whether to assign a WTRU to become a positioning synchronization source for a group of WTRUs based on whether the WTRU has synchronization offset information between itself and other WTRUs in the group. For example, the group may require one WTRU to transmit positioning synchronization to the group if the WTRU (e.g., P-WTRU) does not have synchronization offset information between itself and one or multiple WTRUs. For example, the group may require one WTRU to transmit positioning synchronization to the group if the WTRU (e.g., P-WTRU) does not obtain synchronization offset information from one or multiple WTRU within the group for a period.

A WTRU (e.g., P-WTRU) may determine whether to assign a WTRU to become a positioning synchronization source for a group of WTRUs based on the position method used for the group. For example, the WTRU may not require any WTRU in the group to transmit positioning synchronization signals to the group for the synchronization error tolerant positioning method such as RTT, and angle-based method. However, the WTRU may require one WTRU to transmit positioning synchronization to the group for synchronization error sensitive positioning method such as OTDOA, TDOA methods.

A WTRU (e.g., P-WTRU) may determine whether to assign a WTRU to become a positioning synchronization source for a group of WTRUs based on the configured highest priority of synchronization as gNB/eNB or GNSS. For example, the WTRU may require one WTRU in the group to transmit positioning synchronization signals to the group if the WTRU is (pre-)configured GNSS as the highest synchronization priority. Otherwise, if gNB/eNB is (pre-)configured as the highest synchronization priority, the WTRU may not require any WTRU in the group to transmit positioning synchronization signals to the group.

In one embodiment, a WTRU may trigger sending positioning synchronization signal to the group of WTRU based on one or any combination of the following.

A WTRU may trigger sending positioning synchronization signal to the group of WTRU based on the WTRU changing the synchronization source. Superficially, the WTRU may trigger sending a sidelink positioning synchronization signal to the group if it changes the synchronization source. For example, if the WTRU change the synchronization from one syncRef WTRU (i.e., synchronization reference WTRU) to another SyncRef WTRU, the WTRU may trigger sensing a synchronization positioning synchronization signal to the group. For example, the WTRU may trigger sending a sidelink positioning synchronization signal to the group if it changes synchronization from gNB/eNB to a syncRef WTRU or from syncRef WTRU to a gNB/eNB.

A WTRU may trigger sending positioning synchronization signal to the group of WTRU based on the WTRU changing the coverage status. For example, the WTRU may trigger sending a sidelink positioning signal to the group if it changes from out of coverage to in coverage of a cell or if it changes from in coverage to out of coverage of a cell.

A WTRU may trigger sending positioning synchronization signal to the group of WTRU based on the WTRU receiving an indication from another WTRU which implicitly trigger sending the positioning synchronization to the group.

A WTRU may trigger sending positioning synchronization signal to the group of WTRU based on the SL-PRS transmission. For example, the WTRU may trigger a transmission of a sidelink positioning synchronization signal based on its SL-PRS transmission. Specifically, the WTRU may transmit a sidelink positioning synchronization signal before each SL-PRS transmission.

A WTRU may trigger sending positioning synchronization signal to the group of WTRU based on the SL-PRS reception. For example, the WTRU may trigger a transmission of a sidelink positioning synchronization signal based on its SL-PRS reception. Specifically, the WTRU may transmit a sidelink positioning synchronization signal before each SL-PRS reception resource.

A WTRU may trigger sending positioning synchronization signal to the group of WTRU based on the SL-PRS reception period. For example, the WTRU may perform periodic SL-PRS reception. The WTRU may determine to transmit a sidelink positioning synchronization signal per SL-PRS reception period. The WTRU may transmit a sidelink positioning synchronization signal before each SL-PRS reception period.

A WTRU may trigger sending positioning synchronization signal to the group of WTRU based on the reception of sidelink positioning measurement report. For example, the WTRU may perform reception of sidelink positioning measurement report. The WTRU may determine to transmit a sidelink positioning synchronization signal per reception of sidelink positioning measurement report.

A WTRU may trigger sending positioning synchronization signal to the group of WTRU based on the transmission of sidelink position measurement report period. For example, the WTRU may perform transmission of sidelink positioning measurement report. The WTRU may determine to transmit a sidelink positioning synchronization signal per transmission of sidelink positioning measurement report.

In some methods, a WTRU may determine the WTRU to transmit a synchronization signal. In some approaches, the P-WTRU may determine to become a synchronization source. In some approaches a WTRU (e.g., P-WTRU) may determine which WTRU to transmit positioning synchronization signals to synchronize the sidelink timing of the WTRUs in the group. The synchronization source WTRU (i.e., the WTRU transmitting synchronization signals) may be selected based on one or any combination of parameters or conditions.

For instance, the synchronization source WTRU (i.e., the WTRU transmitting synchronization signals) may be selected based on the location of the WTRUs in the group. For example, one WTRU (e.g., P-WTRU) may select a synchronization source WTRU. The coordinate of the synchronization source WTRU may be closest to the weighted average coordinates of all WTRUs or a set of WTRUs in the group. This approach may be motivated to select the synchronization source WTRU in the middle of the group.

The synchronization source WTRU (i.e., the WTRU transmitting synchronization signals) may be selected based on positioning information of the WTRU. For example, one WTRU may be selected as a synchronization source WTRU if it has the location error bound being smaller than a threshold.

The synchronization source WTRU (i.e., the WTRU transmitting synchronization signals) may be selected based on movement information of the WTRU. For example, one WTRU may be selected as a synchronization source if its speed is smaller than a threshold. For example, a fixed WTRU may be selected as a synchronization source. For example, a WTRU having low relative speed with the P-WTRU may be selected as a synchronization source WTRU.

The synchronization source WTRU (i.e., the WTRU transmitting synchronization signals) may be selected based on the sidelink channel between the synchronization source WTRU and another WTRU (e.g., P-WTRU). For example, one WTRU may be selected as a synchronization source if the sidelink between itself and the P-WTRU (e.g., SL-RSRP, SL-RSSI, SL-RSRQ) is greater than a threshold. In some examples, one WTRU may be selected as a synchronization source if it has the strongest link between itself and the P-WTRU (e.g., highest SL-RSRP, SL-RSSI, or SL-RSRQ).

The synchronization source WTRU (i.e., the WTRU transmitting synchronization signals) may be selected based on LOS/NLOS detection. For example, one WTRU may be selected as a synchronization source if the sidelink between itself and the P-WTRU is considered as LOS.

The synchronization source WTRU (i.e., the WTRU transmitting synchronization signals) may be selected based on coverage information and/or WTRU state information. For example, in a group having both InC and OoC WTRUs, the InC may be selected as a synchronization source. For example, in a group having different RRC states WTRUs, one RRC_CONNECTED WTRU may be selected as a synchronization source WTRU.

The synchronization source WTRU (i.e., the WTRU transmitting synchronization signals) may be selected based on synchronization information. For example, a WTRU may be selected as a synchronization source WTRU if it is synchronized to the highest priority synchronization source.

In some methods, a WTRU may trigger positioning synchronization signal transmission. For example, the WTRU may trigger positioning synchronization transmission or trigger requesting another WTRU to transmit positioning synchronization signals. The triggering may be based on one or any combination of parameters or conditions.

The triggering may be performed when one or multiple parameters of sidelink positioning measurement reporting is out of an expected range. The expected range of a parameter (e.g., RSTD) may be determined by the WTRU based on the estimated distance between two WTRUs or may be indicated by the other WTRU. The triggering may be performed when the WTRU has not received one or multiple expected sidelink measurement reporting. The triggering may be performed when the speed of the WTRU and/or relative speed with other WTRU (e.g., P-WTRU) becomes greater and/or smaller than a threshold. The triggering may be performed when the WTRU synchronizes to a higher/lower synchronization priority. The triggering may be performed when a sidelink measurement among two WTRUs becomes greater/smaller than a threshold. The triggering may be performed when the WTRU detects a NLOS link with another WTRU. The triggering may be performed when the WTRU moves out of coverage or moves in network coverage.

In some methods, a WTRU may determine the resources to transmit a synchronization signal. For example, in some solutions, the resources for synchronization transmission may be configured or pre-configured per carrier and/or per resource pool. The synchronization resource may be configured or pre-configured for positioning synchronization. Alternatively, or additionally, the synchronization resource may be configured or pre-configured for both positioning synchronization and normal data transmission. The WTRU may be configured or pre-configured with periodic synchronization transmission resources. In each period, the WTRU may be configured or pre-configured one or multiple transmission occasions. In some solutions, the WTRU may autonomously select the resource for synchronization transmissions. The WTRU may perform semi-persistent synchronization resource selection and/or dynamic synchronization resource selection.

The WTRU may determine one or any combination of the following: the periodicity of the synchronization transmission; the number of synchronization transmissions per synchronization period; and/or whether a synchronization signal is transmitted in one synchronization resource, which may be configured or pre-configured or selected by the WTRU.

Such determinations may be based on one or any combination of conditions or parameters, such as a property of the synchronization source such as the priority, the ID, the coverage status, or similar. For example, the WTRU may be configured or pre-configured with one set of synchronization resources per synchronization priority. The WTRU may select the synchronization resource accordingly based on the priority of the synchronization source.

Such determinations may be based on the periodicity of the SL-PRS and/or positioning measurement reporting. For example, the WTRU may determine the synchronization period to align with the SL-PRS transmission period. The synchronization transmission resource may occur may be transmitted before each SL-PRS period. For example, the WTRU may determine to transmit in one synchronization period every N SL-PRS period. Alternatively, the WTRU may determine to transmit in N synchronization periods per one SL-PRS period. The information of N (e.g., the exact value of N, the minimum value of N, the maximum value of N) may be configured or pre-configured per resource pool and/or positioning service.

Such determinations may be based on QoS requirements of the positioning service. Specifically, the WTRU may determine the periodicity and/or the number of synchronization transmissions per period based on the QoS requirement of the positioning service. For example, the WTRU may select the low synchronization periodicity and a high number of synchronization transmissions per period for high accuracy requirement position service. Alternatively, the WTRU may select the high synchronization periodicity and a low number of synchronization transmissions per period for low accuracy requirement positioning service. Such determinations may also be based on a CBR of the resource pool and/or CR of the WTRU.

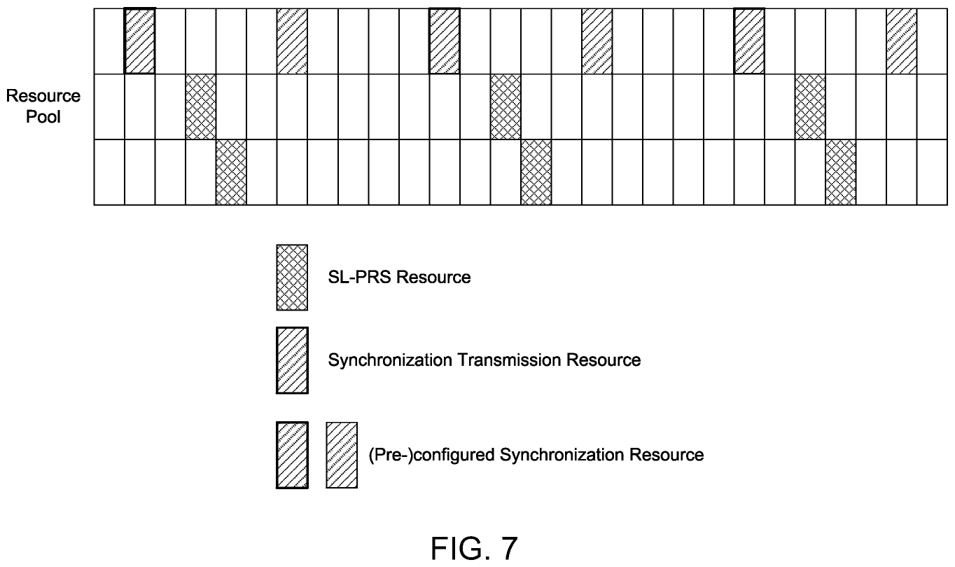

FIG. 7 illustrates an example in which a WTRU may determine which resource to use to transmit synchronization signals. As shown in FIG. 7, the WTRU may be configured or pre-configured with one synchronization resource per synchronization period. The WTRU may be indicated (e.g., by P-WTRU) the SL-PRS pattern for transmissions of one or group of WTRUs, which may include the SL-PRS periodicity. The WTRU may then determine to transmit the synchronization signals before each SL-PRS period.

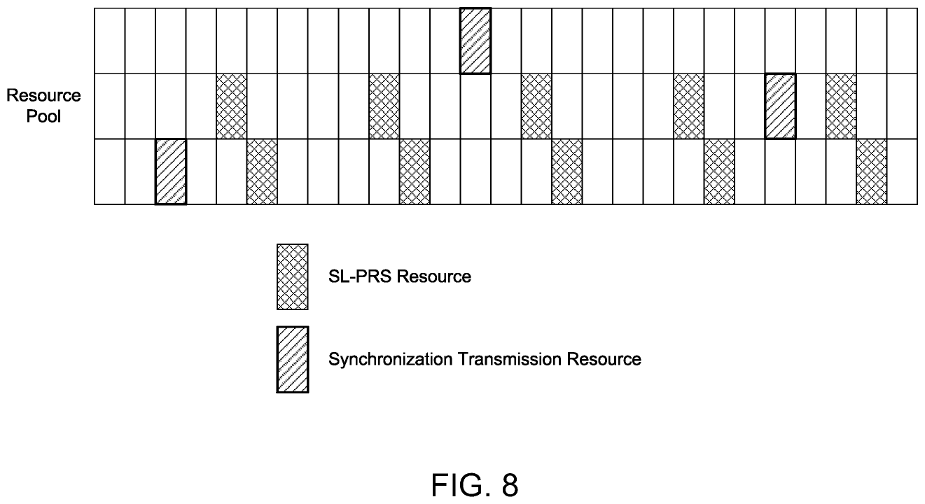

FIG. 8 illustrates an example in which a WTRU dynamically selects a synchronization transmission resource. As shown in FIG. 8, the WTRU may be indicated with the SL-PRS periodicity for a group of WTRUs. The WTRU may then perform dynamic synchronization resource selection and transmit the synchronization signals in the selected resource every 2 SL-PRS periods.

In some approaches, a network node (e.g., gNB) may indicate which WTRU is to transmit positioning synchronization signals to synchronize the group of WTRUs. The network node (e.g., gNB) may also schedule the resource for positioning synchronization signal transmission.

A WTRU may indicate further information related to the synchronization transmissions. The parameters may be included in the channel associated with the positioning synchronization signals (e.g., PSBCH, PSDCH, PSCCH, and/or PSCCH). The information may be one or any combination of the following: the location of the WTRU; the identity of the WTRU; the identity of the positioning group; synchronization information; or coverage status of the WTRU.

In some methods, a WTRU may determine which synchronization source to synchronize with. In some such methods, a WTRU may detect multiple synchronization sources, in which one source may be associated with the positioning synchronization and another source may be associated with the normal sidelink data transmission. The WTRU and/or the group of WTRUs (e.g., P-WTRU and its A-WTRUs) may determine its synchronization source based on one or any combination of parameters or conditions. For example, the WTRU may determine its synchronization source based on a configuration or pre-configuration. For instance, the WTRU may be configured or pre-configured to always synchronize to the positioning synchronization source for the positioning related transmission/reception such as SL-PRS, positioning measurement reporting, etc. Alternatively, or additionally, the WTRU may be configured or pre-configured to always synchronize to a normal sidelink data transmission for both normal data transmission and positioning related transmission/reception.

The WTRU may determine its synchronization source based on a priority of the synchronization source. Specifically, the WTRU may synchronize to the source having higher synchronization priority. The synchronization source WTRU may be configured or pre-configured with a rule to determine the priority of its synchronization transmissions. The synchronization transmission priority may be indicated in the synchronization transmission. Alternatively, or additionally, the priority of the synchronization source may be configured or pre-configured per positioning service.

The WTRU may determine its synchronization source based on the SL-RSRP associated with the synchronization source. For example, the WTRU may synchronize to the synchronization source if the SL-RSRP of the synchronization source is greater than a threshold and/or the WTRU may synchronize to the synchronization source having the highest SL-RSRP.

The WTRU may determine its synchronization source based on a coverage status of one or multiple WTRUs in the group. Specifically, the WTRU (e.g., P-WTRU) may determine which synchronization source to be synchronized for the group (e.g., P-WTRU and A-WTRUs) based on the coverage status of the WTRU. For example, for out of coverage scenario (i.e., all WTRU in the group is out of coverage), the group of WTRUs may be synchronized to GNSS or a synchronization source WTRU. Alternatively, or additionally if all WTRUs in the group are in coverage, the synchronization source of the group may be a gNB or another network node, a synchronization source WTRU, or a GNSS. Finally, if the group of the WTRU is in partial coverage, the synchronization source of the group of the WTRU may be GNSS or a synchronization source WTRU.

In some examples, the group of WTRUs may determine to synchronization to the gNB or another network node if all the WTRUs in the group are in the coverage of one gNB or another network node or one PLMN.

In some example, if one or multiple WTRUs within the group (e.g., P-WTRU and A-WTRUs supporting the P-WTRU) are in the network coverage, the group of the WTRUs may synchronize to one of the WTRUs in the network coverage. The selected WTRUs may then transmit synchronization signals for other WTRUs to synchronize its transmission/reception of the positioning signals. Alternatively, or additionally for this scenario, all WTRUs may select GNSS as its synchronization source.

In some examples, if all WTRUs in the group are out of coverage, the group of WTRU may select one of the WTRUs to transmit synchronization signals. The WTRU to transmit synchronization signal may be determined by the other conditions. Alternatively, or additionally all WTRUs may use GNSS as the synchronization source if all WTRUs are out of coverage.

The WTRU may determine its synchronization source based on a Uu RSRP. In some examples, the group of WTRUs may select the WTRU to be the synchronization source based on Uu RSRP of the of the WTRU. Specifically, the P-WTRU may select the WTRU as a synchronization source if it has the highest Uu RSRP.

The WTRU may determine its synchronization source based on a SL-SSB-RSRP. In some examples, the group of WTRUs may select the WTRU to be the synchronization source based on SL-SSB-RSRP of the of the synchronization source. Specifically, the P-WTRU may select the WTRU as a synchronization source if it has the highest SL-SSB-RSRP. The SL-SSB-RSRP may be included in the response message sent to the P-WTRU.

The WTRU may determine its synchronization source based on a QoS of the positioning service.

The WTRU may determine its synchronization source based on the positioning method used to determine the position of the WTRU.

In some methods, a WTRU may pre-compensate the over the air (OTA) time of the positioning synchronization signals from the source. In one such method, the WTRU may determine its sidelink transmission timing by performing the pre-compensation of the synchronization transmission time. Specifically, at first, the WTRU may determine the transmission duration of the positioning synchronization signals, the WTRU may then shift its sidelink transmission timing based on the transmission duration of the synchronization signals (e.g., the WTRU may shift its sidelink transmission timing a period being equal to the OTA time of the synchronization signal). The transmission OTA time of the synchronization signal may be determined based on the distance between the synchronization source WTRU and the WTRU itself. Alternatively, it may be indicated by the synchronization source (e.g., similar to TA).

In some embodiments, a WTRU may determine a SL-SSB-RSRP threshold to transmit a SL-SSB. For instance, in some solutions, the WTRU may be configured or pre-configured with two SL-SSB-RSRP thresholds to determine whether it should transmit SL-SSB or not, in which one threshold may be associated with normal sidelink communication and another threshold may be associated with positioning service. The WTRU, when being configured with positioning service may use the threshold associated with positioning service. In some cases, when it is not configured with the positioning service may use the threshold associated with the normal sidelink communication.

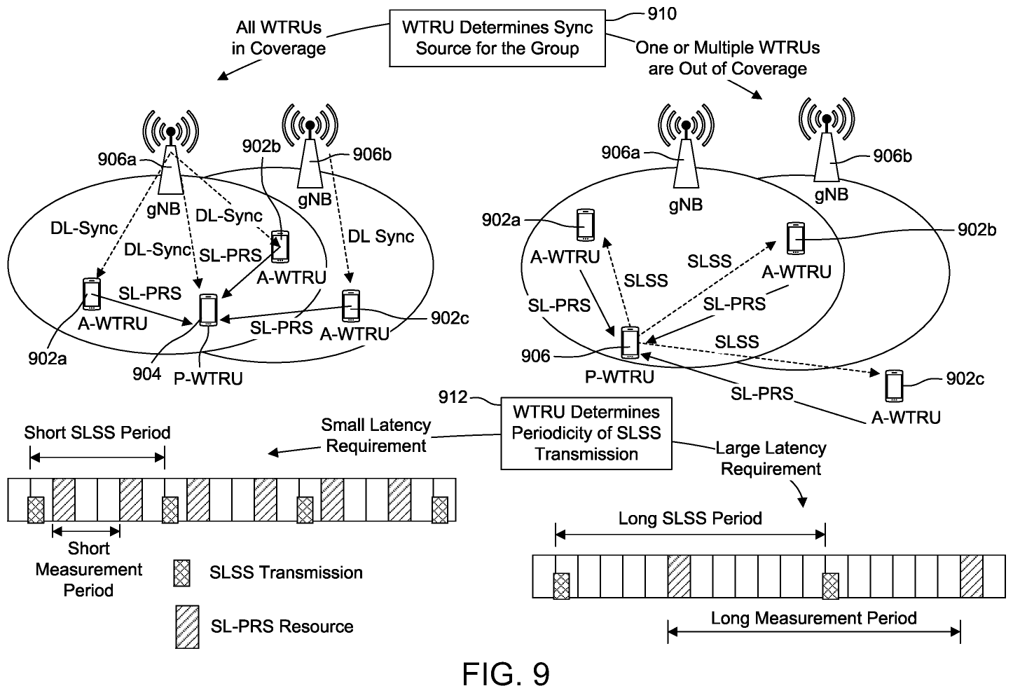

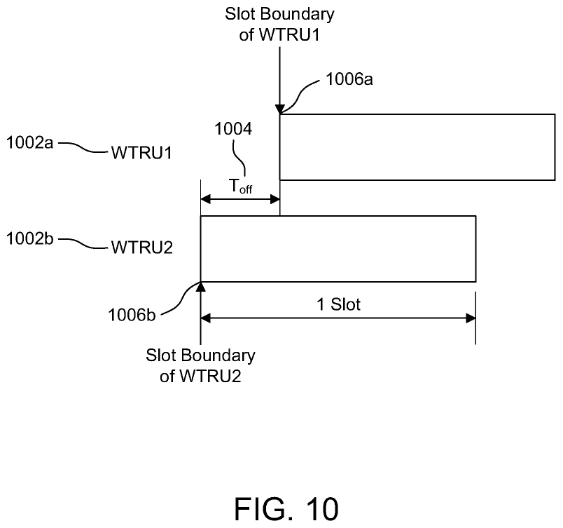

FIG. 9 illustrates a scenario in which all A-WTRUs 902a, 902b, and 902c are in coverage and a scenario in which one more A-WTRUs 902a, 902b, and/or 902c are out of coverage. As illustrated in FIG. 9, in the “out-of-coverage” scenario, A-WTRU 902c is out of coverage.

At 910, the P-WTRU 904 determines a sync source for the group of A-WTRUs 902a, 902b, and 902c. If all the A-WTRUs 902a, 902b, and 902c are in coverage of the network, the gNB may serve as the sync source. Conversely, if one or more A-WTRUs 902a, 902b, or 902c are out of network coverage (e.g., A-WTRU 902c as shown in FIG. 9), the P-WTRU 904 will serve as the sync source.

Furthermore, at 912, the P-WTRU determines the periodicity of SLSS transmission. As shown in FIG. 9, the positioning service may have a small latency requirement or a large latency requirement. If there is a small latency requirement, there may be a short SLSS period. If there is a large latency requirement, there may be a large SLSS period.

In another embodiment, a WTRU may determine the synchronization offset between itself and another node (e.g., another WTRU, RSU, gNB, etc.). The synchronization offset may be determined as the slot boundary difference between two WTRUs.

FIG. 10 illustrates an exemplary synchronization offset between two WTRUs. As shown in FIG. 10, WTRU1 1002a and WTRU2 1002b have the time offset (i.e., T_{off}) 1004 between the slot boundary 1006a of WTRU1 1002a and the slot boundary 1006b of WTRU 1006b.

In another embodiment, a WTRU may perform a procedure to determine the synchronization offset between the WTRU and another WTRU. For example, the WTRU may perform RTT and measurement reporting to determine the synchronization offset between the WTRU and another WTRU.

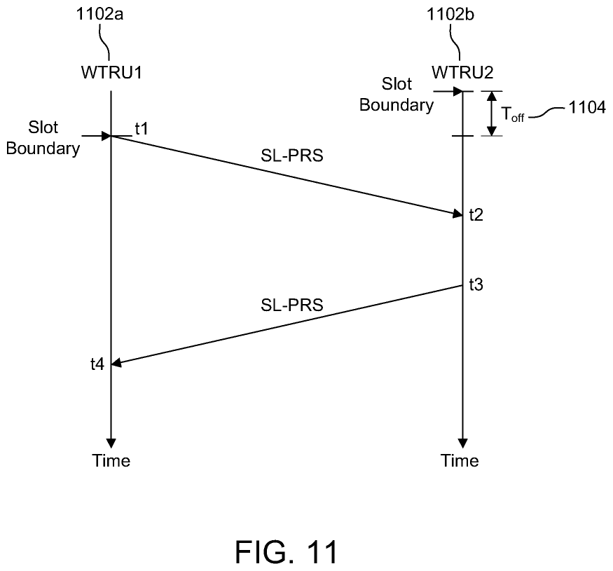

FIG. 11 illustrates an exemplary procedure to determine T_{off} 1104 between two WTRUs, 1102a and 1102b. As indicated in FIG. 11, WTRU1 1102a may perform transmission/reception of SL-PRS and receive the measurement reporting from WTRU2 1102b (e.g., t2, t3, and/or t3-t2) to determine the synchronization offset between WTRU1 1102a and WTRU2 1102b. The synchronization offset between WTRU 1102a and WTRU2 1102b may be determined as a function of t1, t2, t3, and t4. Specifically, T_{off} 1104 may be calculated as follow:

$$Toff = \frac{( t 2 + t 3 ) - ( t 1 + t 4 )}{2}$$

The WTRU may further calculate the RTT, which may indicate two times the propagation time between two WTRUs, as follow:

$$R T T = \frac{( t 4 - t 1 ) - ( t 3 - t 2 )}{2}$$

In another embodiment, the WTRU may trigger a synchronization offset determination procedure (e.g., RTT transmission/reception and measurement reporting procedure) to determine the synchronization offset between the WTRU (e.g., P-WTRU) and another WTRU (e.g., A-WTRU). The WTRU trigger may be based on one or any combination of the following: (1) periodic; (2) the WTRU changes the synchronization source; (3) the WTRU changes the coverage status; and/or (4) the WTRU receives an indication from another WTRU which implicitly/explicitly indicate the possibility of the synchronization offset change between the two WTRUs.

In another embodiment, a WTRU may transmit the information about synchronization offset between two WTRUs to another node. Specifically, a P-WTRU may send the information about synchronization offset between itself and other WTRUs (e.g., A-WTRU) to the network. In one approach, the synchronization offset between the WTRU (e.g., P-WTRU) and other WTRU (e.g., A-WTRU) may be calculated by the WTRU itself. Alternatively, the synchronization offset between the WTRU (e.g., P-WTRU) and another WTRU (e.g., A-WTRU) may be conveyed to the WTRU by the A-WTRU. In another approach, a A-WTRU may transmit the information about the synchronization offset among different A-WTRU to the P-WTRU or to the network. These procedures may be motivated to help the P-WTRU or the network to calculate the position of the P-WTRU accurately.

In another embodiment, a WTRU may send timing advance (TA) information to another node to support the node in calculating the position of the P-WTRU. In one example, an A-WTRU may send TA information for the P-WTRU to calculate its position. A-WTRU may send its TA information in the sidelink positioning measurement message. A WTRU (e.g., P-WTRU) may further send the TA information of all A-WTRUs in the group to the network to help the network in determining its positioning information. In another example, a A-WTRU may transmit its TA information to the network directly.

In another embodiment, a WTRU (e.g., P-WTRU) may receive the position information from the A-WTRUs in the group. The WTRU may then receive the position information of the gNB for each corresponding A-WTRU. The WTRU may then determine the TA information of each A-WTRU to determine the synchronization offset between itself and each WTRU. For WTRU assisted positioning method, the WTRU may then forward the location information of the A-WTRUs in the group to the network. This approach may be motivated to help the network in determining the position of the WTRU based on sidelink.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a first wireless transmit/receive unity (WTRU), the method comprising:
requesting support from one or more candidate assistant WTRUs (A-WTRUs);
receiving a response message from one or more candidate A-WTRUs, wherein the response message includes information indicating a coverage status within a network of the one or more candidate A-WTRUs;
determining, based on the received response messages, a set of A-WTRUs from the one or more candidate A-WTRUs;
determining, based on the coverage status of each one of the determined set of A-WTRUs, a synchronization source; and
reporting, to the determined set of A-WTRUs, the determined synchronization source.

2. The method of claim 1, wherein the determining of the set of A-WTRUs from the one or more candidate A-WTRUs is based on a Quality of Service (QoS) requirement of a positioning service of the first WTRU.

3. The method of claim 1, wherein, on a condition that each of the A-WTRUs of the determined set are within coverage of the network, the determined synchronization source is a base station.

4. The method of claim 1, wherein, on a condition that at least one of the A-WTRUs of the determine set is not within coverage of the network, the determined synchronization source is any WTRU.

5. (canceled)

6. The method of claim 4, wherein the first WTRU sends information to the determined set of A-WTRUs for receiving a Sidelink (SL) Positioning Synchronization Signal (SLPSS) transmission.

7. The method of claim 6, wherein the first WTRU sends the SLPSS transmission to the determined set of A-WTRUs to synchronize the SL Positioning Reference Signals (SL-PRSs) for the determined set of A-WTRUs.

8. The method of claim 7, wherein the SLPSS transmission is one of a SL-PRS, Sidelink Synchronization Signal (SLSS), Demodulation Reference Signal (DMRS), Phase Tracking Reference Signal (PTRS), or Channel State Information Reference Signal (CSI-RS).

9. The method of claim 4, wherein the first WTRU determines a periodicity of the SLPSS transmission based on a Quality of Service (QoS) requirement of a positioning service associated with the determined set of A-WTRUs.

10. The method of claim 9, wherein the first WTRU sends the SLPSS transmission using the determined periodicity.

11. A first wireless transmit/receive unit (WTRU) comprising:
a transmitter;
a receiver; and
a processor;
wherein the transmitter is configured to request support from one or more candidate assistant WTRUs (A-WTRUs);
wherein the receiver is configured to receive a response message from one or more candidate A-WTRUs, wherein the response message includes information indicating a coverage status within a network of the one or more candidate A-WTRUs;
wherein the processor is configured to determine, based on the received response messages, a set of A-WTRUs from the one or more candidate A-WTRUs;
wherein the processor is further configured to determine, based on the coverage status of each one of the determined set of A-WTRUs, a synchronization source; and
wherein the receiver is further configured to report, to the determined set of A-WTRUs, the determined synchronization source.

12. The first WTRU of claim 11, wherein the processor is further configured to determine the set of A-WTRUs from the one or more candidate A-WTRUs based on a Quality of Service (QoS) requirement of a positioning service of the WTRU.

13. The first WTRU of claim 11, wherein, on a condition that each of the A-WTRUs of the determined set are within coverage of the network, the determined synchronization source is a base station.

14. The first WTRU of claim 11, wherein, on a condition that at least one of the A-WTRUs of the determine set is not within coverage of the network, the determined synchronization source is any WTRU.

15. (canceled)

16. The first WTRU of claim 14, wherein the first WTRU sends information to the determined set of A-WTRUs for receiving a Sidelink (SL) Positioning Synchronization Signal (SLPSS) transmission.

17. The first WTRU of claim 16, wherein the first WTRU sends the SLPSS transmission to the determined set of A-WTRUs to synchronize the SL Positioning Reference Signals (SL-PRSs) for the determined set of A-WTRUs

18. The first WTRU of claim 17, wherein the SLPSS transmission is one of a SL-PRS, Sidelink Synchronization Signal (SLSS), Demodulation Reference Signal (DMRS), Phase Tracking Reference Signal (PTRS), or Channel State Information Reference Signal (CSI-RS).

19. The first WTRU of claim 14, wherein the first WTRU determines a periodicity of the SLPSS transmission based on a Quality of Service (QoS) requirement of a positioning service associated with the determined group of A-WTRUs.

20. The first WTRU of claim 19, wherein the transmitter is further configured to send the SLPSS transmission using the determined periodicity.

21. The method of claim 1, further comprising determining a synchronization offset between the first WTRU and another node.

22. The first WTRU of claim 11, wherein the first WTRU determines a synchronization offset between the first WTRU and another node.
